(19) United States
(12) Patent Application Publication
(10) Pub. No.: US 2008/0319755 A1
(43) Pub. Date: Dec. 25, 2008

(54) Text-to-speech apparatus

(75) Inventors: Rika Nishiike, Kawasaki (JP); Hitoshi Sasaki, Kawasaki (JP); Nobuyuki Katae, Kawasaki (JP); Kentaro Murase, Kawasaki (JP); Takuya Noda, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/213,792

(22) Filed: Jun. 24, 2008

(30) Foreign Application Priority Data
Jun. 25, 2007 (JP) 2007-167018

(51) Int. Cl. G10L 13/00; G10L 13/06; G10L 21/06

(52) U.S. Cl. 704/267; 704/260; 704/276; 704/E13.001; 704/E13.011

(57) ABSTRACT

According to an aspect of an embodiment, an apparatus for converting text data into sound signal, comprises: a phoneme determiner for determining phoneme data corresponding to a plurality of phonemes and pause data corresponding to a plurality of pauses to be inserted among a series of phonemes in the text data to be converted into sound signal; a phoneme length adjuster for modifying the phoneme data and the pause data by determining lengths of the phonemes, respectively in accordance with a speed of the sound signal and selectively adjusting the length of at least one of the phonemes which is placed immediately after one of the pauses so that the at least one of the phonemes is relatively extended timewise as compared to other phonemes; and a output unit for outputting sound signal on the basis of the adjusted phoneme data and pause data by the phoneme length adjuster.

### BACKGROUND OF THE INVENTION

1. Field of the Invention

The present invention relates to devices, programs, and methods for text-to-speech read-aloud for converting character data including phonetic characters in a document and outputting speech. More specifically, the present invention relates to a device, a program, and a method for text-to-speech read-aloud for controlling phoneme lengths, particularly, for increasing/reducing a specific phoneme length and so on, in accordance with a read-aloud speed, such as a high read-aloud speed.

2. Description of the Related Art

Technology for the so-called “text-to-speech read-aloud” is known which analyzes character data including phonetic characters, synthesizes speech from the character data through a speech synthesis technique, and outputs the character data in the form of speech. For mobile terminal devices such as mobile phones, a speech synthesis function for reading aloud arbitrary sentences in electronic mail and so on is beginning to be widely available. For personal computers (PCs), software called “screen readers” is beginning to become popular. For understanding of the contents of a sentence, the lengths of phonemes representing vowels, consonants, pauses, and so on which act on the auditory sense are important factors to enhance recognition.

In relation to such text-to-speech read-aloud, Japanese Laid-open Patent Publication No. 6-149283 (Patent Document 1; e.g., Summary of the Invention and FIG. 1) discloses a speech synthesis technology. That is, when the utterance-speed information indicates a speed that is less than a predetermined value, the speed of utterance is increased to a speed that is greater than a normal speed of utterance based on the utterance-speed information. When the utterance-speed information indicates a speed that has a predetermined value or more, the speed of utterance is reduced to a speed that is less than the normal speed of utterance based on the utterance-speed information. Thus, large mora lengths corresponding to the utterance-speed information are set and the frame period is set to a maximum value.

It is now assumed that the speech speed (i.e., the read-aloud speed) is configured to be settable and each phoneme length is set in reverse portion to the speech speed. For example, when the speech speed is doubled, the phoneme lengths are reduced to ½, and when the speech speed is reduced to ½, the phoneme lengths are doubled. Setting the relationship between the speech speed and the phoneme lengths to have such a simple relationship, i.e., the relationship in which the speech speed and the phoneme lengths are in simple reverse proportion to each other may cause difficulty in hearing, an unpleasant sensation, and a reduction in recognition at a high or low read-aloud speed, even when it sounds natural (i.e., it is easy to hear) at a normal speech speed.

Japanese Laid-open Patent Publication, however, does not disclose or suggest such requirements and problems and also does not disclose or suggest a configuration and so on for addressing the requirements and problems.

### SUMMARY

According to an aspect of an embodiment, an apparatus for converting text data into sound signal, comprises: a phoneme determiner for determining phoneme data corresponding to a plurality of phonemes and pause data corresponding to a plurality of pauses to be inserted among a series of phonemes in the text data to be converted into sound signal; a phoneme length adjuster for modifying the phoneme data and the pause data by determining lengths of the phonemes, respectively in accordance with a speed of the sound signal and selectively adjusting the length of at least one of the phonemes which is placed immediately after one of the pauses so that the at least one of the phonemes is relatively extended timewise as compared to other phonemes; and a output unit for outputting sound signal on the basis of the adjusted phoneme data and pause data by the phoneme length adjuster.

### BRIEF DESCRIPTION OF THE DRAWINGS

FIG. 1 is a block diagram showing an example of the configuration of a text-to-speech read-aloud device according to a first embodiment;

FIG. 2 is a block diagram showing an example of the configuration of a phoneme-length controller in the text-to-speech read-aloud device;

FIG. 3 is a block diagram showing one example of a mobile terminal device incorporating the speech-read-aloud device;

FIG. 4 is an example of the configuration of the mobile terminal device;

FIG. 5 is a schematic view showing an example of display on a screen;

FIG. 6 is a flowchart showing one example of a processing procedure for controlling phoneme lengths according to the first embodiment;

FIG. 7 is a flowchart showing one example of a processing procedure for controlling phoneme lengths according to a second embodiment;

FIG. 8 is a flowchart showing one example of a processing procedure for controlling phoneme lengths according to a third embodiment;

FIG. 9 is a block diagram showing a phoneme-length controller according to a fourth embodiment;

FIG. 10 is a flowchart showing one example of a processing procedure for controlling phoneme lengths according to the fourth embodiment;

FIG. 11 is a block diagram showing a phoneme-length controller according to a fifth embodiment;

FIG. 12 is a flowchart showing one example of a processing procedure for controlling phoneme lengths according to the fifth embodiment;

FIG. 13 is a flowchart showing one example of a processing procedure for controlling phoneme lengths according to a sixth embodiment;

FIG. 14 is a flowchart showing one example of a processing procedure for controlling phoneme lengths according to a seventh embodiment;

FIG. 15 is a flowchart showing one example of a processing procedure for controlling phoneme lengths according to an eighth embodiment;

FIG. 16 is a flowchart showing one example of a processing procedure for controlling phoneme lengths according to a ninth embodiment;

FIG. 17 is a block diagram showing an example of the configuration of a parameter generator in the text-to-speech read-aloud device according to a tenth embodiment;

FIG. 18 is a flowchart showing one example of a processing procedure for controlling phoneme lengths according to the tenth embodiment;

FIG. 19 is a block diagram showing a parameter generator that includes a speech-speed adjusting unit;

FIG. 20 is a flowchart showing one example of a processing procedure for controlling phoneme lengths;

FIG. 21 is a table showing a result of linguistic processing;

FIG. 22 is a table showing an example of generated phoneme lengths;

FIG. 23 is a table showing an example of generated phoneme lengths;

FIGS. 24a, 24b and 24c, respectively, show speech-synthesis waveforms;

FIGS. 25a and 25b, respectively, show speech-synthesis waveforms;

FIGS. 26a and 26b, respectively, show speech-synthesis waveforms;

FIGS. 27a and 27b, respectively, show speech-synthesis waveforms;

FIGS. 28a and 28b, respectively, show speech-synthesis waveforms;

FIGS. 29a and 29b, respectively, show speech-synthesis waveforms;

FIGS. 30a and 30b, respectively, show speech-synthesis waveforms;

FIGS. 31a and 31b, respectively, show speech-synthesis waveforms; and

FIG. 32 is a table showing an example of adjusting of phoneme lengths.

### DESCRIPTION OF THE PREFERRED EMBODIMENTS

### First Embodiment

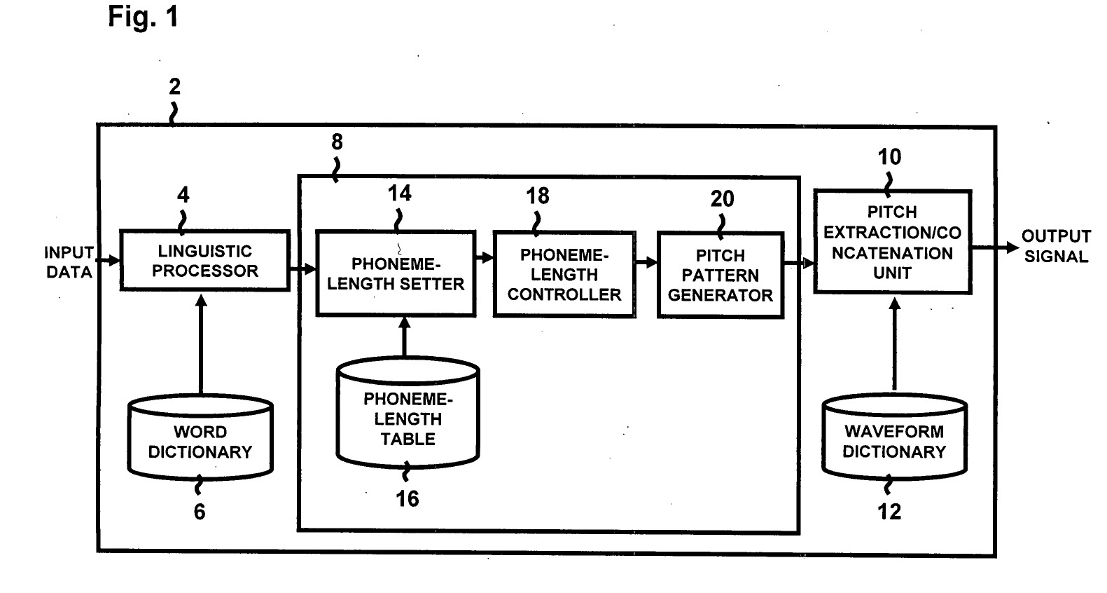

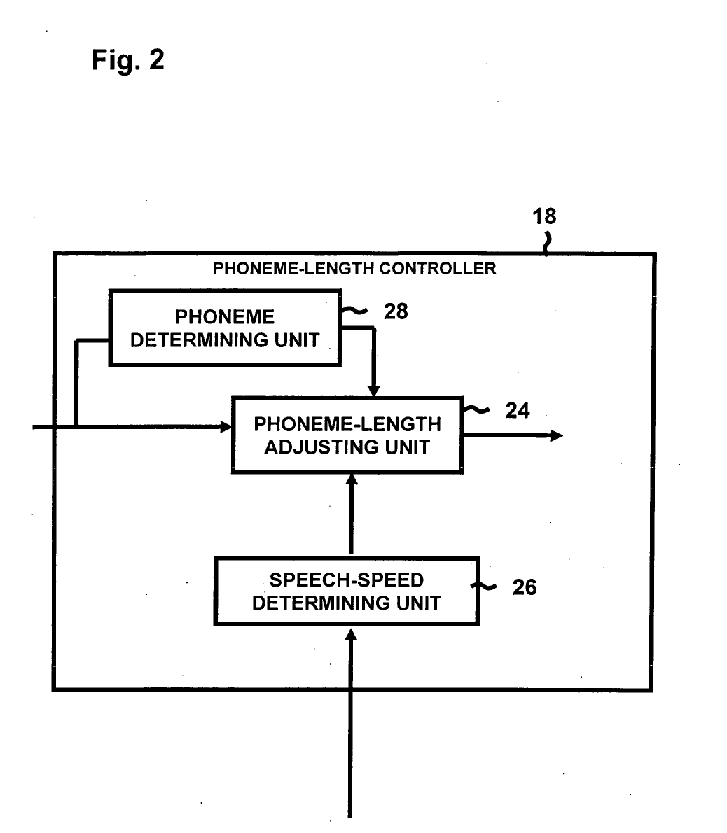

A first embodiment of the present invention will now be described with reference to FIGS. 1 and 2. FIG. 1 is a block diagram showing an example of the configuration of a text-to-speech read-aloud device. FIG. 2 is a block diagram showing an example of the configuration of a phoneme length control unit in the text-to-speech read-aloud device.

This speech read-aloud device (speech reading apparatus, text to speech reading apparatus) 2 is one example of a device configuration, a program, and a method for text-to-speech read-aloud according to the present invention, and is implemented by a computer. For example, the text-to-speech read-aloud device 2 includes a speech synthesizing device that converts character data, such as a text sentence (e.g., text with both kanji and kana in Japanese Language) into speech and outputs the speech. The phoneme length of a phoneme immediately after a pause in the character data is controlled in accordance with a speech speed (i.e., a read-aloud speed) to enhance ease of hearing output speech resulting from the character data and to improve recognition of synthesized speech (read-aloud output). The character data to be read aloud includes phonetic characters, a string of the phonetic characters, and pauses. The phonetic characters or the phonetic character string is an intermediate language including phonetic transcriptions with prosodic symbols which are used for speech synthesis. One example of the phonetic symbols is kana characters. Pauses included in the character data represent voiceless periods, such as a period in which no speech conversion is performed. For example, in a Japanese sentence “so tsugyoshi te, shinyou kin koni . . . ” expressed in Roman characters, a comma “,” representing a voiceless period exists between “so tsugyoshi te” and “shinyou kin ko”, and this comma is one example of pauses. Japanese sentence “so tsugyoshi te, shinyou kin koni . . . ” means “after (he) graduated from (high school), (he has worked) at a bank . . . ”. In other words, “so tsugyoshi te” means “after graduation” and “shinyou kin koni” means “at a bank”. Information whose phoneme length of a phoneme immediately after a pause is to be controlled does not include, for example, a Japanese sokuon (a sound expressed by a small-sized kana character “tsu” in Japanese) and a silent period immediately before a plosive. A Japanese sokuon is called a geminate consonant or double consonant in English. A breath group is a unit of human speech in one breath and is preceded and followed by pauses for breath.

In order to achieve such a function, as shown in FIG. 1, the text-to-speech read-aloud device 2 includes a linguistic processor (language processing unit) 4, a word dictionary 6, a parameter generator (parameter generating unit) 8, a pitch extraction/concatenation unit (pitch extracting/overlapping unit) 10, and a waveform dictionary 12.

The linguistic processor 4 serves as linguistic processing means for inputting text with both kanji and kana, analyzing words by referring to the word dictionary 6, determining phonetic transcriptions, accents, and intonations, and outputting a phonetic character string (intermediate language). The word dictionary 6 contains word types (parses and so on), phonetic transcriptions, accent positions, and so on.

Physically, accent and intonation are closely associated with a temporal change pattern of a pitch frequency. Specifically, the pitch frequency increases at an accent position and decreases according to an increase in intonation. Thus, the linguistic processor 4 divides the input text into breath groups, based on punctuation marks in the text and/or phrases extracted through the word analysis.

The parameter generator 8 serves as parameter generating means for setting phoneme durations, pause durations, and pitch frequency patterns. The parameter generator 8 controls phoneme lengths in accordance with the speech speed.

The parameter generator 8 includes a phoneme-length setter (phoneme length setting unit) 14, a phoneme-length table 16, a phoneme-length controller (phoneme length control unit) 18, and a pitch pattern generator (pitch pattern generating unit) 20.

At the stage of the phonetic character string generated by the linguistic processor 4, which phonemes are to be speech-synthesized are determined. The phoneme-length setter 14 serves as means for setting the phoneme length of each phoneme, and sets a phoneme length at a normal speech speed. The phoneme-length table 16 serves as means for storing phoneme lengths that are used at a normal speech speed and that are associated with a phoneme and preceding and subsequent phonemes. Accordingly, as an example for setting the phoneme lengths, phoneme lengths (values extracted from a database) that are used at a normal speech speed and that are associated with a phoneme and preceding and subsequent phonemes are stored in the phoneme-length table 16, and phoneme lengths are set with reference to the values. The phoneme lengths may be modified according to another parameter element.

The phoneme-length controller 18 serves as phoneme-length controlling means. That is, in accordance with a speech speed, the phoneme-length controller 18 controls the phoneme lengths used at the normal speech speed and set by the phoneme-length setter 14. The speech speed is supplied, as control information, from means (not shown) for adjusting a read-aloud speed (set by a user or the like) or the like to the phoneme-length controller 18.

As shown in FIG. 2, the phoneme-length controller (phoneme length control unit) 18 includes a phoneme-length adjusting unit (phoneme length adjusting unit) 24, a speech-speed determining unit (speech rate determining unit, speaking rate determining unit) 26, and a phoneme determining unit 28. In response to an output resulting from determination of each of the speech-speed determining unit 26 and the phoneme determining unit 28, the phoneme-length adjusting unit 24 adjusts the length of a phoneme or the length of a pause. The speech-speed determining unit 26 determines the input speech speed, determines which of a normal speed, a high speed, a low speed the speech speed is, and supplies the resulting determination output to the phoneme-length adjusting unit 24. In this case, the determination output supplied from the speech-speed determining unit 26 includes an output indicating the level of the speech speed, i.e., the normal speed, high speed, or low speed. The phoneme determining unit 28 determines phonemes having the phoneme length set by the phoneme-length setter 14 (FIG. 1), a pause, and so on, and supplies the resulting determination output to the phoneme-length adjusting unit 24.

According to the phoneme-length controller 18, a phoneme length is adjusted so that it is inversely proportional to a predetermined speech speed relative to a normal speech speed. For example, when the normal speech speed is assumed to be about 7 moras per second and a speech speed of 14 moras per second is set, each phoneme-length is adjusted to half, and when a speech speed of 6 moras per second is set, each phoneme length is adjusted to 7/6. In this case, a mora represents a beat and is a unit corresponding to substantially one character when written in kana characters. Kana characters that have diphthongs (e.g., small-sized Japanese kana characters “ya”, “yu”, and “yo”, which are expressed in Roman characters for convenience of description), for example, a kana character “kya”, are each one mora. In the case of Japanese language, one character (mora) has a similar length.

The pitch pattern generator 20 serves as pattern generating means for setting a pitch period for each phoneme considering accent information and so on in a phonetic character string.

The pitch extraction/concatenating unit 10 serves as pitch cutting-out/concatenating means that employs, for example, a PSOLA (Pitch Synchronous OverLap and Add) method, which is a pitch conversion method using a waveform overlap-add technique). The waveform dictionary 12 contains phoneme labels indicating to which phonemes specific parts of sound correspond and a pitch mark indicating a pitch period for voiced sound. The pitch extraction/concatenation unit 10 extracts a speech waveform corresponding to two periods from the waveform dictionary 12 based on a parameter generated by the parameter generator 8, multiplies the speech waveform by a window function (e.g., a Hanning window), and executes processing for multiplying the resulting waveform by a gain for amplitude adjustment, as required. Thereafter, when a desired pitch frequency is different from a pitch frequency in the waveform dictionary 12, the pitch extraction/concatenation unit 10 performs pitch conversion, overlaps and adds the extracted waveforms, and outputs a synthesized speech signal.

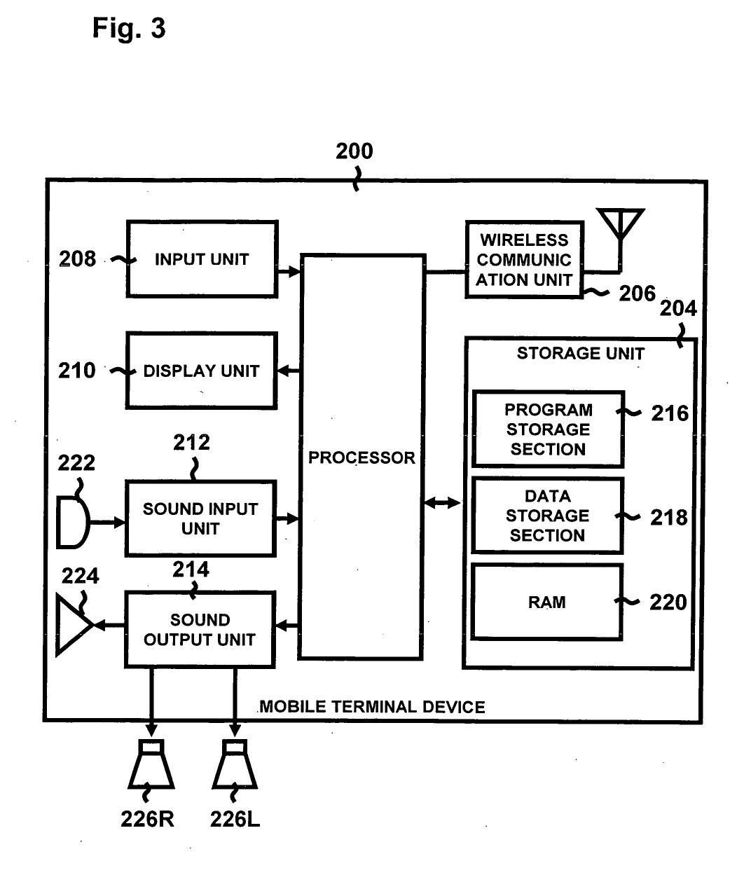

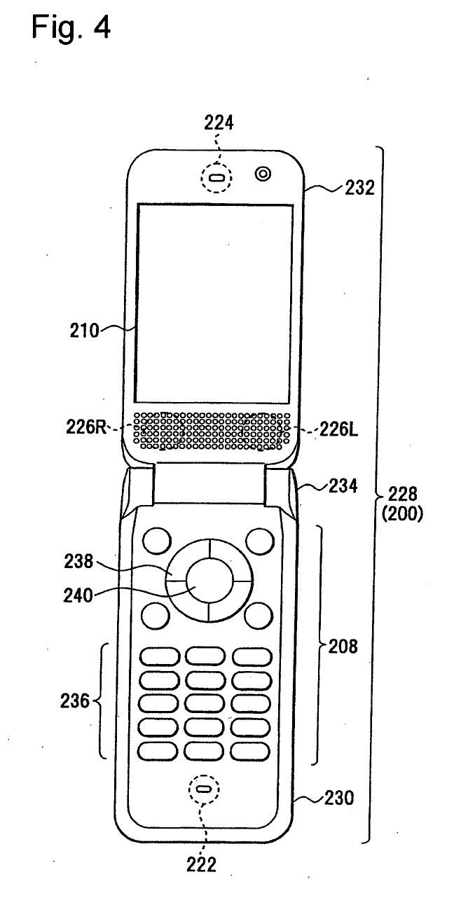

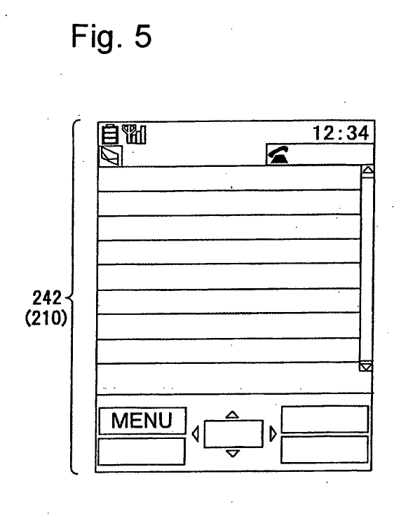

The hardware of the text-to-speech read-aloud device 2 will now be described with reference to FIGS. 3, 4, and 5. FIG. 3 is a block diagram showing one example of a mobile terminal device incorporating the text-to-speech read-aloud device 2, FIG. 4 is a schematic view showing an example of the configuration of the mobile terminal device, and FIG. 5 is a an example of display on a screen.

This mobile terminal device (portable terminal, portable terminal device) 200 is one example to which the text-to-speech read-aloud device 2 is applied, and the device, method, and program for text-to-speech read-aloud according to the present invention are not limited to the configuration of the mobile terminal device 200. The mobile terminal device 200 has a communication function and a function for converting character data for a text sentence (e.g., text with both kanji and kana in the case of Japanese language), such as electronic mail text, into speech and outputs the speech. Thus, as shown in FIG. 3, the mobile terminal device 200 includes a processor 202, a storage unit 204, a wireless communication unit (radio unit, wireless unit) 206, an input unit 208, a display unit 210, a sound input unit (speech input unit, voice input unit) 212, and a sound output unit (speech output unit, voice output unit) 214.

The processor 202 serves as controlling means for controlling phone communication, execution of speech read-aloud, such as speech synthesis, and so on. The processor 202 is implemented by a CPU (central processing unit) or an MPU (micro processor unit) to execute an OS (operating system) and application programs stored in the storage unit 204. The application programs include a program for executing a procedure for speech-read-aloud processing.

The storage unit 204 is a storage medium that stores the programs executed by the processor 202 and various data used for the execution and that also provides a processing area. The storage unit 204 includes a program storage section 216, a data storage section 218, and a RAM (random access memory) 220. The program storage section 216 stores the OS and the application programs. The data storage section 218 contains the word dictionary 6, the waveform dictionary 12, the phoneme-length table 16 (FIG. 1), and the above-mentioned data. The RAM 220 provides a work area.

The wireless communication unit 206 serves as wireless communicating means for wirelessly transmitting/receiving audio-signal radio waves, packet-signal radio waves, and so on to/from a base station. The wireless communication unit 206 is controlled by the processor 202.

The input section 208 serves as means for inputting, through user operation, control data and a response to a dialog displayed on the display unit 210. The inputting means 208 includes a keyboard, a touch panel, and so on.

The display unit 210 is controlled by the processor 202 and serves as displaying means for displaying characters, graphics, and so on. The display unit 210 is implemented by, for example, an LCD (liquid crystal display) device. The display unit 210 displays a text sentence for read-aloud and so on.

The sound input unit 212 serves as sound inputting means, which is controlled by the processor 202. The sound input unit 212 includes a microphone 222. Input sound is converted by the microphone 222 into an audio signal, which is then converted into a digital signal and is sent to the processor 202.

The sound output unit 214 serves as sound outputting means, which is controlled by the processor 202. The sound output unit 214 includes a receiver 224 and speakers 226R and 226L which serve as sound converting means. Synthesized speech for read-aloud is reproduced by the receiver 224 and the speakers 226R and 226L.

In the mobile terminal device 200, the text-to-speech read-aloud device 2 described above is constituted by the processor 202, the storage unit 204, the display unit 210, the sound output unit 214, and so on.

As shown in FIG. 4, the mobile terminal device 200 has a body 228, which includes, for example, a first body unit 230 and a second body unit 232. The body units 230 and 232 are coupled with each other via a hinge portion 234 so as to be foldable. The body unit 230 has the input unit 208 and the microphone 222. The body unit 232 has the display unit 210, the receiver 224, and the speakers 226R and 226L. The input unit 208 has symbol keys 236 used for inputting characters and so on, cursor keys 238, and an enter key 240, and so on.

The mobile terminal device 200 can read-aloud various text sentences, including electronic-mail text and novel text. A sentence or the like displayed on a screen 242 of the display unit 210 is speech-synthesized and the speech is reproduced by the receiver 224 or the speakers 226R and 226L. In this case, as shown in FIG. 5, mail text is displayed on the screen 242 on the display unit 210 and is output in the form of speech. In this example, a sentence “yamanashiken no koukou wo so tsugyoshi te shinyou kin koni haitte 4nenme desu.” is displayed on the screen 242 and is reproduced in the form of speech. “yamanashiken no koukou wo so tsugyoshi te shinyou kin koni haitte 4nenme desu” represents Japanese pronunciation. A Japanese sentence “yamanashiken no koukou wo so tsugyoshi te shinyou kin koni haitte 4nen me desu” also means “after he graduated from high school, he has worked at a bank for 4 years” in English.

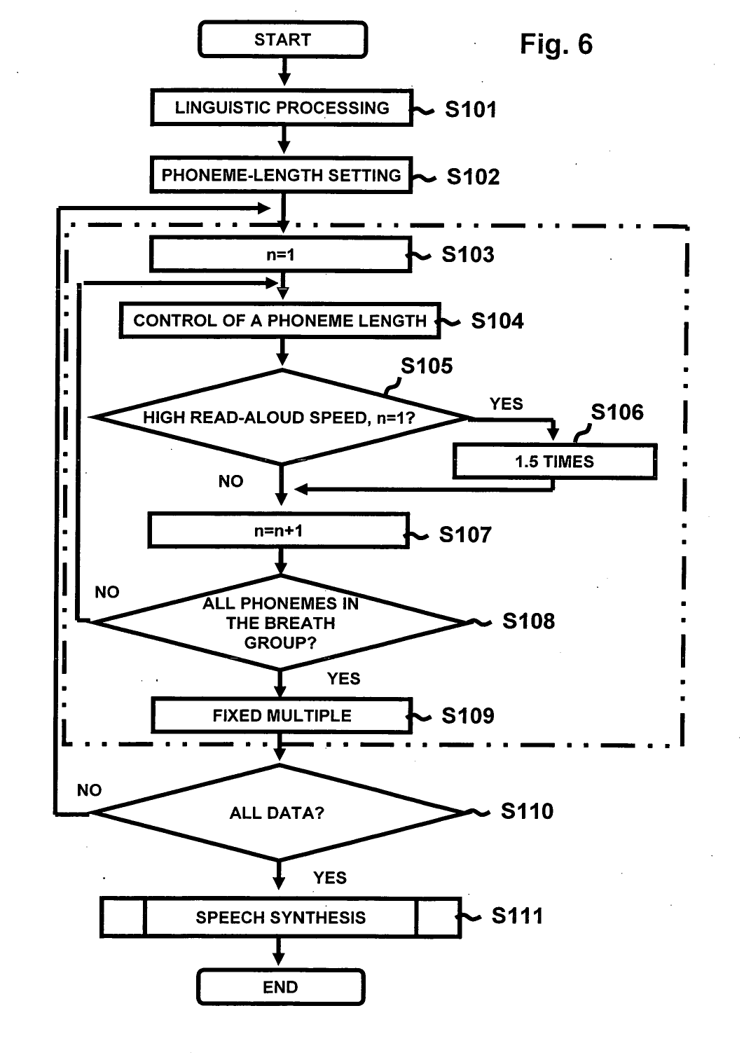

Control of phoneme lengths will now be described with reference to FIG. 6. FIG. 6 is a flowchart showing one example of a processing procedure for controlling phoneme lengths according to the first embodiment.

This processing procedure is one example of a program or method for text-to-speech read-aloud. The processing in the first embodiment includes a process or step of determining whether or not a phoneme in question is a phoneme immediately after a pause, i.e., a speech head (the first phoneme in each breath group), and also includes, as a process or step of controlling the phoneme length, a process or step of increasing the phoneme length of the phoneme when the phoneme is a phoneme at the speech head. This processing procedure is executed by the phoneme-length controller 18 (FIG. 2) in the text-to-speech read-aloud device 2 (FIG. 1). In this embodiment, the speech head is modified is modified in accordance with the speech speed and the phoneme length is set to 1.5 times the phoneme length of other phonemes, to enhance ease of hearing.

In the processing procedure, as shown in FIG. 6, in step S101, linguistic processing is executed, and in step S102, phoneme-length setting processing is executed. Specifically, the linguistic processor 4 executes the linguistic processing (step S101) to generate a phonetic character string based on input data, and determines which phoneme is to be speech-synthesized at this stage. Next, the phoneme-length setter 14 executes the phoneme-length setting processing (step S102) to set a phoneme length at a normal speech speed with respect to each phoneme. In this case, with reference to the phoneme-length table 16, each phoneme length is set to a phoneme length used at a normal speech speed corresponding to the phoneme and preceding and subsequent phonemes.

After the phoneme-length setting processing, as processing for phonemes in a breath group, in step S103, a phoneme number n is initialized (n=1), and in steps S104 to S110, control of a phoneme length is performed in accordance with a speech speed. The phoneme-length control is executed for each breath group. A flow from steps S105 to S109 shows processing for phonemes in the breath group. The phoneme-length control includes processing for determining phonemes to be controlled and processing for adjusting phoneme lengths according to the determination results.

Based on recognition of input speech-speed information, the phoneme-length controller 18 controls the phoneme length in accordance with the speech speed. In this case, in step S104, the phoneme length is set to a fixed multiple. In step S105, a determination is made as to whether or not the set speech speed is high read-aloud speed and also determines whether or the phoneme in question is the first phoneme (i.e., n=1). Thus, in this processing, the phoneme length of a phoneme immediately after a pause is specified as a phoneme length to be adjusted.

When the speech speed is high read-aloud speed and the phoneme is the first phoneme (n=1; i.e., YES in step S105), the phoneme length is set or adjusted to a predetermined multiple, for example, 1.5 times, in step S106. On the other hand, when the speech speed is not high and/or the phoneme is not the first phoneme (n=1; i.e., NO in step S105), the phoneme length is not adjusted. After the adjustment or non-adjustment, in step S107, the phoneme number n is updated (i.e., n=n+1). In step S108, a determination is made as to whether or not the processing on all phonemes in the breath group is completed, i.e., the numbers n of the phonemes in the breath group have reached the number n of phonemes. Consequently, the processing of all phonemes in the breath group is processed.

When the processing on all phonemes in the breath group is completed and the pause at the end of the breath group is reached, in step S109, the length of the pause is set to a fixed multiple in accordance with the speech speed. In step S110, a determination is made as to whether or not processing on all data of the input data is completed. Until the processing on all data is completed, the processing from steps S103 to S110 is repeated. After the completion processing, speech synthesis is executed in step S111 and speech is output.

As described above, the first phoneme in each breath group is modified in accordance with the speech speed and the phoneme length of a phoneme immediately after a pause is adjusted to, for example, 1.5 times during high-speed read-aloud. This arrangement eliminates unclearness during high-speed read-aloud to thereby facilitate hearing, and can improve the recognition of text converted into speech.

### Second Embodiment

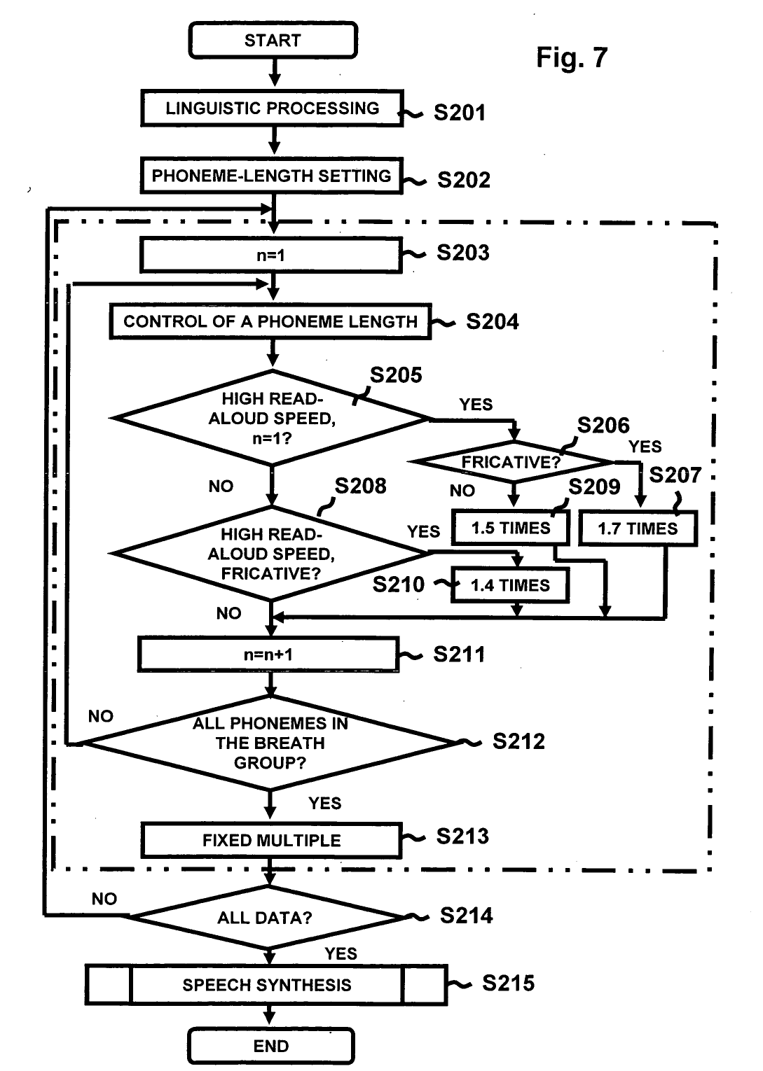

A second embodiment of the present invention will now be described with reference to FIG. 7. FIG. 7 is a flowchart showing one example of a processing procedure for controlling-phoneme lengths according to a second embodiment.

This processing procedure is one example of a program or method for text-to-speech read-aloud, and is executed using the text-to-speech read-aloud device 2 (FIG. 1) and the phoneme-length controller 18 (FIG. 2). In the second embodiment, a determination is made as to whether or not a phoneme is a fricative, in addition to the phoneme-length adjustment performed in the first embodiment. Further, when the speech speed is high read-aloud speed, the phoneme length of the determined fricative is increased to adjust the phoneme length. This arrangement can enhance ease of hearing without an excessive increase in the total amount of reproduction time for text-to-speech read-aloud.

In the second embodiment, in order to identify a phoneme whose phoneme length is to be increased, the phoneme determining unit 28 (FIG. 2) determines whether or not the phoneme is a fricative. Based on the determination, the processing for increasing the phoneme length of the fricative is executed.

In the processing procedure, as shown in FIG. 7, in step S201, linguistic processing is executed, and in step S202, phoneme-length setting processing is executed. After the linguistic processing (step S201) and the phoneme-length setting processing (step S202), as processing for phonemes in a breath group, in step S203, a phoneme number n is initialized (n=1), and in steps S204 to S214, control of the phoneme length is performed in accordance with the speech speed. The phoneme-length control is performed for each breath group, as in the first embodiment.

Based on recognition of input speech-speed information, the phoneme-length controller 18 controls the phoneme length in accordance with the speech speed. In this case, in step S204, the phoneme-length controller 18 sets the phoneme length to a fixed multiple. In step S205, the phoneme-length controller 18 determines whether or not the speech speed is high read-aloud speed and the phoneme is the first phoneme (n=1)). In this determination processing, the phoneme length of a phoneme (a speech head) immediately after a pause is specified as a phoneme length to be adjusted.

When the speech speed is high read-aloud speed and the phoneme is the first phoneme (n=1; i.e., Yes in step S205), a determination is made as to whether or not the phoneme is a fricative in step S206. When the speech speed is high read-aloud speed and the phoneme is the first phoneme (n=1) and a fricative (YES in step S206), the phoneme length of the phoneme is set or adjusted to a predetermined multiple α (e.g. α=1.7) in step S207. When the phoneme is neither the first phoneme (n=1) nor a fricative (No in step S208), the phoneme length thereof is not adjusted. That is, in this case, the state in which the phoneme length was set to the fixed multiple in step S204 is maintained.

On the other hand, when the speech speed is high read-aloud speed and the phoneme is the first phoneme (No in step S206), the phoneme length thereof is set or adjusted to a predetermined multiple β (e.g., β=1.5) in step S209. When the speech speed is high read-aloud speed and the phoneme is a fricative (Yes in step S208), the phoneme length thereof is set or adjusted to a predetermined multiple γ (e.g., γ=1.4) in step S210.

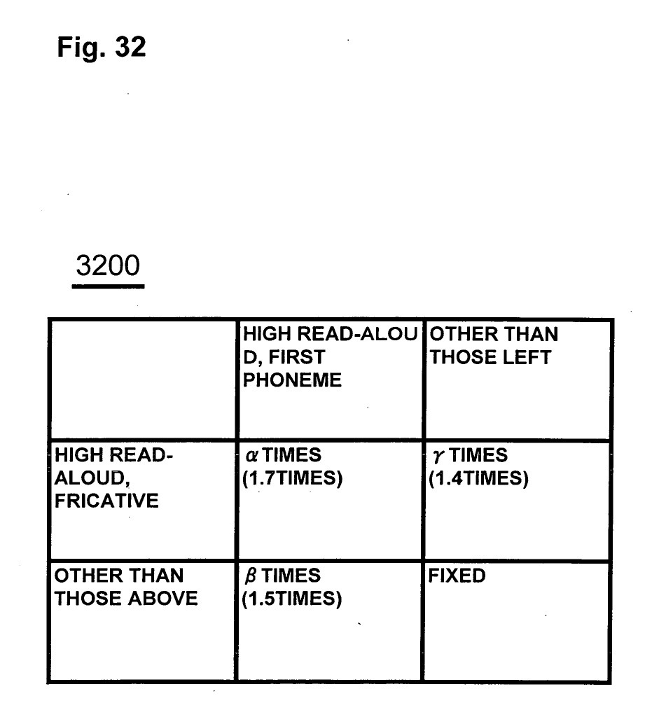

Thus, when the speech speed is high read-aloud speed and the phoneme is the first phoneme and a fricative, when the speech speed is high read-aloud speed and the phoneme is the first phoneme, when the speech speed is high read-aloud speed and the phoneme is a fricative, or when the phoneme is neither the first phoneme nor a fricative, the phoneme length thereof is adjusted or not adjusted as shown in table 3200 (FIG. 32).

After the processing described above, in step S211, the phoneme number n is updated (n=n+1). In step S212, a determination is made as to whether or not the processing on all phonemes in the breath group is completed. As a result of the processing, the processing of all phonemes in the breath group is executed.

When all phonemes in the breath group have been processed and the pause at the end of the breath group is reached, the length of the pause is set to be a fixed multiple in accordance with the speech speed in step S213. In step S214, a determination is made as to whether or not the processing on all data is completed. Until the processing on all data is completed, the processing from steps S203 to S214 is repeated. After the completion of the processing, speech synthesis is executed in step S215 and speech is output.

Thus, the first phoneme and a fricative in each breath group are modified in accordance with the speech speed, and when a phoneme in question is a phoneme immediately after a pause and/or a fricative or when the phoneme in question is neither thereof, the degree of the increase in the phoneme length is varied. Thus, ease of hearing synthesized speech is enhanced and recognition of read-aloud text converted into speech is improved.

### Third Embodiment

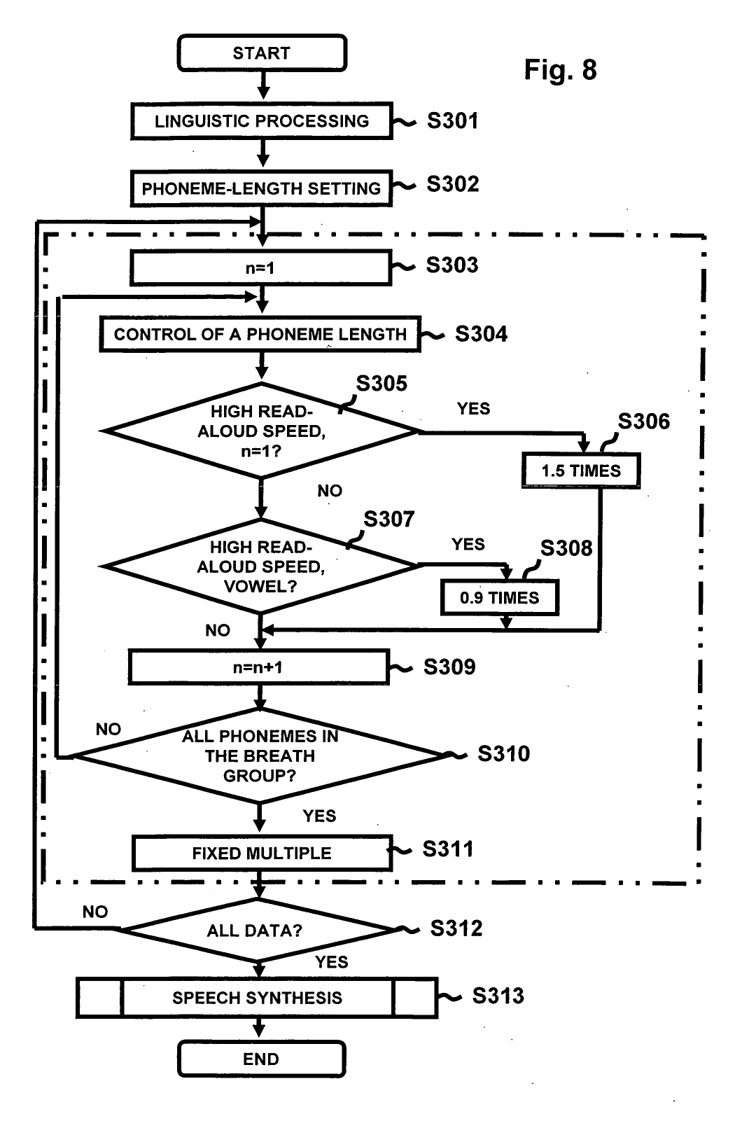

A third embodiment of the present invention will now be described with reference to FIG. 8. FIG. 8 is a flowchart showing one example of a processing procedure for controlling phoneme lengths according to a third embodiment.

This processing procedure is one example of a program or method for text-to-speech read-aloud, and is executed using the text-to-speech read-aloud device 2 (FIG. 1) and the phoneme-length controller 18 (FIG. 2). In the third embodiment, in addition to the phoneme-length adjustment performed in the first embodiment, i.e., relative to an increase in the phoneme length of a phoneme, the phoneme lengths of other phonemes are reduced, to thereby enhance ease of hearing without an increase in the amount of time for converting read-aloud text into speech. In this embodiment, the phoneme lengths of vowels as the other phonemes are reduced.

In the third embodiment, in order to identify a phoneme whose phoneme length is to be adjusted, the phoneme determining unit 28 (FIG. 2) determines whether or not a phoneme is a vowel. Based on the determination, processing for reducing the phoneme length of the vowel is executed.

In this processing procedure, as shown in FIG. 8, in step S301, linguistic processing is executed, and in step S302, phoneme-length setting processing is executed. As processing for phonemes in a breath group, in step S303, a phoneme number n is initialized (n=1), and in steps S304 to S312, control of the phoneme length is performed in accordance with the speech speed. The phoneme-length control is performed for each breath group, as in the first embodiment.

Based on recognition of input speech-speed information, the phoneme-length controller 18 controls the phoneme length in accordance with the speech speed. In this case, in step S304, the phoneme length is set to a fixed multiple, and in step S305, a determination is made as to whether or not the speech speed is high read-aloud speed and the phoneme is the first phoneme (n=1). In this determination processing, the phoneme length of a phoneme (a speech head) immediately after a pause is specified as a phoneme length to be adjusted.

When the speech speed is high read-aloud speed and the phoneme is the first phoneme (n=1; i.e., Yes in step S305), the phoneme length is set or adjusted to a predetermined multiple, for example, 1.5 times, in step S306. When the speech speed is not high and/or the phoneme is not the first phoneme (n=1; i.e., No in step S305), the phoneme length thereof is not adjusted.

After the processing, in step S307, a determination is made as to whether or not the speech speed is high read-aloud speed and the phoneme is a vowel. When the speech speed is high read-aloud speed and the phoneme is a vowel (Yes in step S307), the phoneme length of the phoneme is set or adjusted to a predetermined multiple, for example, 0.9 times, in step S308. When the phoneme is not a vowel (No in step S307), the phoneme length thereof is not adjusted.

After the adjustment or non-adjustment, in step S309, the phoneme number n is updated (i.e., n=n+1). In step S310, a determination is made as to whether or the processing on all phonemes in the breath group is completed. When the pause at the end of the breath group is reached after the processing on all phonemes in the breath group is executed, the length of the pause is set to a fixed multiple in accordance with the speech speed in step S311. In step S312, a determination is made as to whether or not the processing is completed. Until the processing on all data is completed, the processing from steps S303 to S312 is repeated. After the completion processing, speech synthesis is executed in step S313 and speech is output.

As described above, the first phoneme and a vowel in each breath group are modified in accordance with the speech speed. That is, the phoneme length of a phoneme immediately after a pause is set to, for example, 1.5 times, whereas the phoneme length of a vowel is set to, for example, 0.9 times. As a result, the time of the increased phoneme length is complemented by a reduction in the phoneme length of the vowel. Thus, ease of hearing synthesized speech is enhanced and recognition of read-aloud text converted into speech improved while substantially maintaining the total length without an increase in the overall reproduction time of output speech.

### Fourth Embodiment

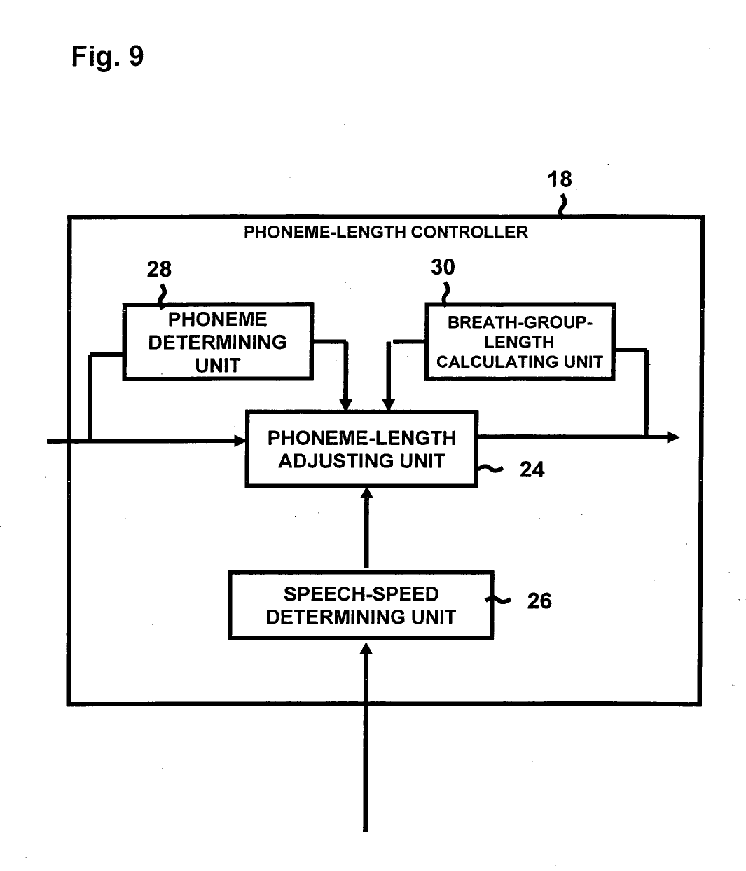

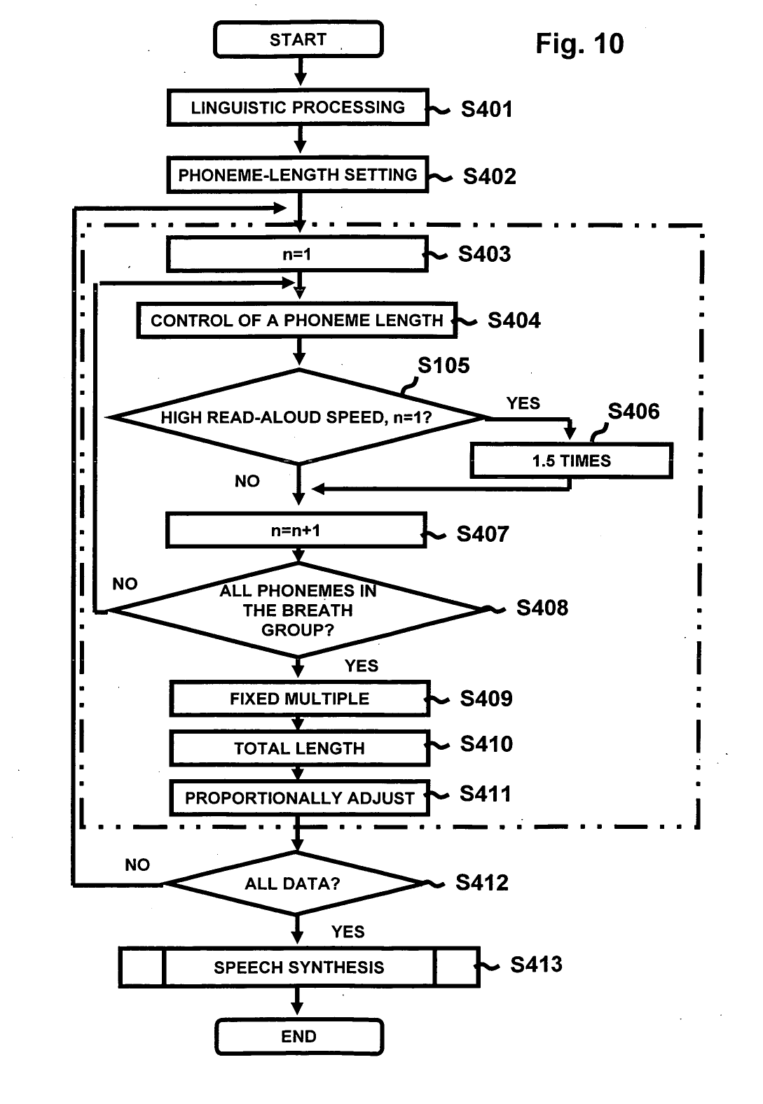

A fourth embodiment of the present invention will now be described with reference to FIGS. 9 and 10. FIG. 9 is a block diagram showing a phoneme-length controller according to a fourth embodiment. FIG. 10 is a flowchart showing one example of a processing procedure for controlling phoneme lengths according to the fourth embodiment. In FIG. 9, same units as those in FIG. 2 are denoted by the same reference numerals.

This processing procedure is one example of a program or method for text-to-speech read-aloud, and is executed using the text-to-speech read-aloud device 2 (FIG. 1) and the phoneme-length controller 18 (FIG. 2). In addition to the adjustment of a phoneme length in the first embodiment (i.e., relative to the increase in the phoneme length of a speech head), the phoneme lengths of other phonemes in the breath group are proportionally reduced by an amount corresponding to the increase in the phoneme length of the speech head, to thereby enhance ease of hearing while maintaining the length of the breath group without an increase in the amount of time for converting read-aloud text into speech.

In the fourth embodiment, the phoneme-length controller 18 (FIG. 2) in the text-to-speech read-aloud device 2 (FIG. 1) further has a breath-group-length calculating unit (phrase length calculating unit) 30. The breath-group-length calculating unit 30 calculates a total length of a breath group, based on an output from the phoneme-length adjusting unit 24. A result of the calculation is sent to the phoneme-length adjusting unit 24 as control information. The phoneme-length adjusting unit 24 has a function for performing control so that the amount of time for reading aloud the breath group has a predetermined value by proportionally reducing the phoneme lengths of all phonemes in the breath group by an amount corresponding to an increase in the phoneme length of a specific phoneme, specifically in this case, the phoneme length of the first phoneme.

In this processing procedure, as shown in FIG. 10, in step S401, linguistic processing is executed, and in step S402, phoneme-length setting processing is executed. As processing for phonemes in a breath group, in step S403, a phoneme number n is initialized (n=1), and in step S404 to S412, control of the phoneme length is performed in accordance with a speech speed. The phoneme-length control is performed for each breath group, as in the first embodiment.

Based on recognition of input speech-speed information, the phoneme-length controller 18 controls the phoneme length in accordance with the speech speed. In this case, in step S404, the phoneme length is set to a fixed multiple, and in step S405, a determination is made as to whether or not the speech speed is high read-aloud speed and the phoneme is the first phoneme (n=1). Thus, in the determination processing, the phoneme length of a phoneme (a speech head) immediately after a pause is specified as a phoneme length to be adjusted.

When the speech speed is high read-aloud speed and the phoneme is the first phoneme (n=1; i.e., Yes in step S405), the phoneme length is set or adjusted to a predetermined multiple, for example, 1.5 times, in step S406. When the speech speed is not high and/or the phoneme is not the first phoneme (n=1;, i.e., No in step S405), the phoneme length thereof is not adjusted.

After the adjustment or non-adjustment, in step S407, the phoneme number n is updated (i.e., n=n+1). In step S408, a determination is made as to whether or the processing on all phonemes in the breath group is completed. When the pause at the end of the breath group is reached after the processing on all phonemes in the breath group is executed, the length of the pause is set to a fixed multiple in accordance with the speech speed in step S409.

After the setting, in step S410, a total length of the breath group is calculated. In step S411, the phoneme lengths of all phonemes are proportionally adjusted so that the length of the breath group becomes a predetermined length, for example, a length that is the same as or similar to the length when the phoneme lengths are not increased. In step S412, a determination is performed whether or not the processing on all data is completed. Until the processing on all data is completed, the processing from steps S403 to S412 is repeated. After the completion processing, speech synthesis is executed in step S413 and speech is output.

As described above, the first phoneme in each breath group is adjusted in accordance with the speech speed, that is, the phoneme length of a phoneme immediately after a pause is adjusted to, for example, 1.5 times, whereas other phonemes in the breath group are proportionally reduced by an amount corresponding to the increase in the phoneme length of the first phoneme. This arrangement enhances ease of hearing synthesized speech while maintaining the length of the breath group and improves recognition of read-aloud text converted into speech.

### Fifth Embodiment

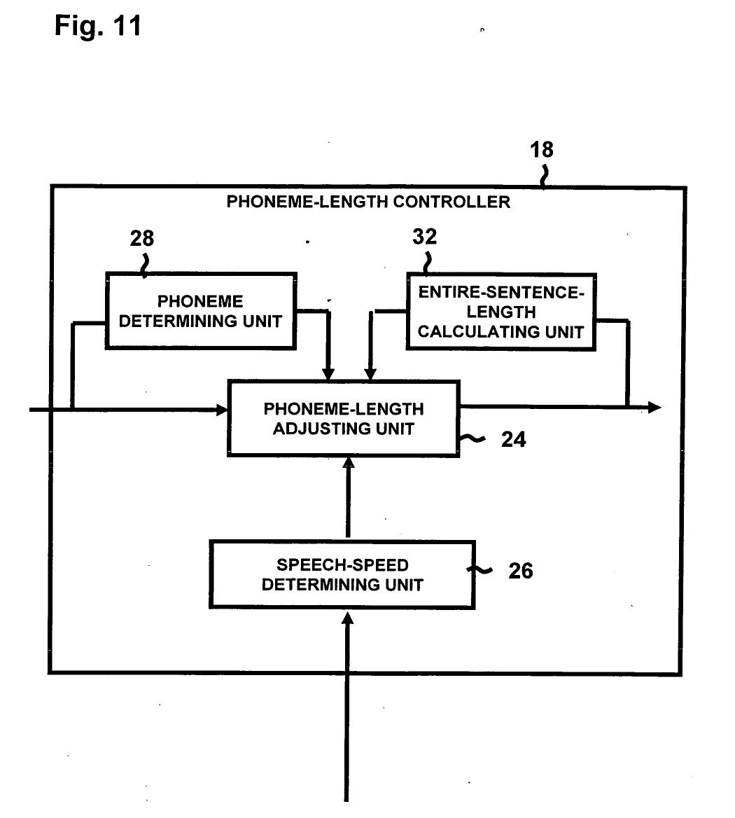

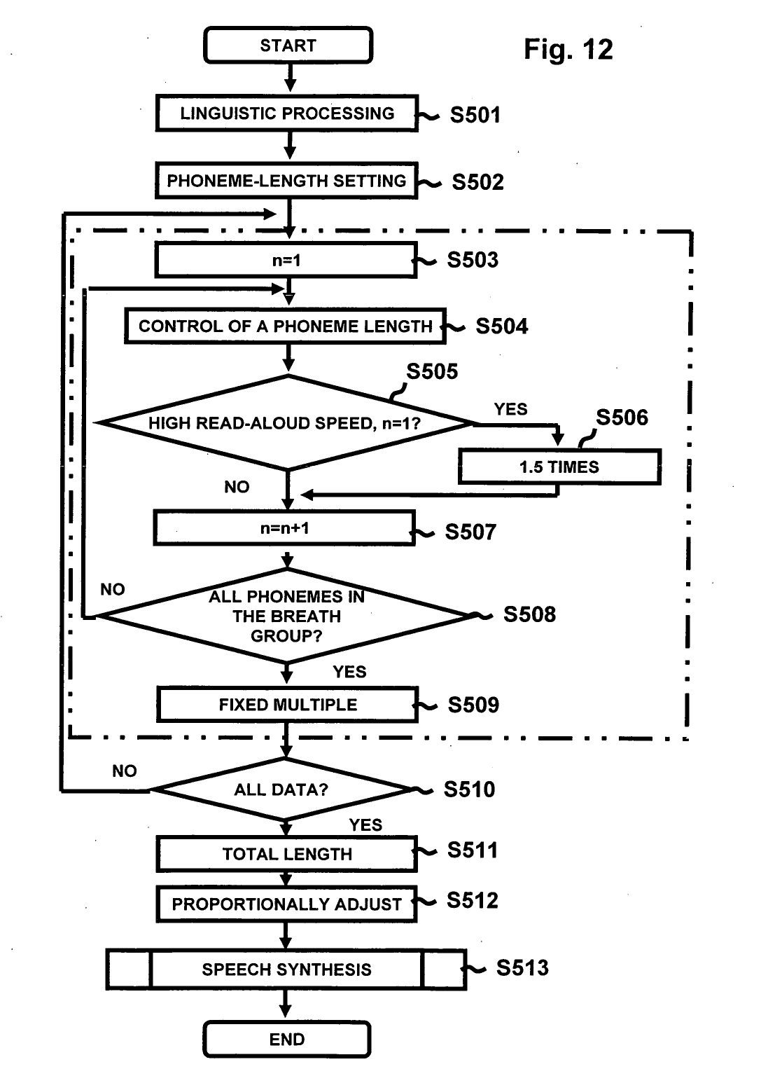

A fifth embodiment of the present invention will now be described with reference to FIGS. 11 and 12. FIG. 11 is a block diagram showing a phoneme-length controller according to a fifth embodiment. FIG. 12 is a flowchart showing one example of a processing procedure for controlling phoneme lengths according to the fifth embodiment. In FIG. 11, same units as those in FIG. 2 are denoted by the same reference numerals.

This processing procedure is one example of a program or method for text-to-speech read-aloud, and is executed using the text-to-speech read-aloud device 2 (FIG. 1) and the phoneme-length controller 18 (FIG. 2). In the fifth embodiment, in addition to the adjustment of a phoneme length in the first embodiment (i.e., relative to the increase in the phoneme length of a speech head), the phoneme lengths in the entire sentence are proportionally reduced by an amount corresponding to the increase in the phoneme length of the speech head, to thereby enhance ease of hearing while maintaining the length of the entire sentence without an increase in the amount of time for converting read-aloud text into speech.

In the fifth embodiment, the phoneme-length controller 18 (FIG. 2) in the text-to-speech read-aloud device 2 (FIG. 1) further has an entire-sentence-length calculating unit (total text length calculating unit) 32, as shown in FIG. 11. The entire-sentence-length calculating unit 32 calculates a total length of a sentence, based on an output from the phoneme-length adjusting unit 24. A result of the calculation is sent to the phoneme-length adjusting unit 24 as control information. In this case, the phoneme-length adjusting unit 24 has a function for performing control so that the amount of time for reading aloud the sentence has a predetermined value by proportionally reducing the phoneme lengths of all phonemes in the entire sentence by an amount corresponding to an increase in the phoneme length of a specific phoneme, specifically in this case, the phoneme length of the first phoneme.

In this processing procedure, as shown in FIG. 12, in step S501, linguistic processing is executed, and in step S502, phoneme-length setting processing is executed. As processing for phonemes in a breath group, in step S503, a phoneme number n is initialized (n=1), and in steps S503 to S512, control of the phoneme length is performed in accordance with the speech speed. The phoneme-length control is performed for each breath group, as in the first embodiment.

Based on recognition of input speech-speed information, the phoneme-length controller 18 controls the phoneme length in accordance with the speech speed. In this case, in step S504, the phoneme length is set to a fixed multiple, and in step S505, a determination is made as to whether or not the speech speed is high read-aloud speed and whether or not the phoneme is the first phoneme (n=1). Thus, in the determination processing, the phoneme length of a phoneme (a speech head) immediately after a pause is specified as a phoneme length to be adjusted.

When the speech speed is high read-aloud speed and the phoneme is the first phoneme (n=1; i.e., Yes in step S505), the phoneme length is set or adjusted to a predetermined multiple, for example, 1.5 times, in step S506. When the speech speed is not high and/or the phoneme is not the first phoneme (n=1; i.e., No in step S505), the phoneme length thereof is not adjusted.

After the adjustment or non-adjustment, in step S507, the phoneme number n is updated (i.e., n=n+1). In step S508, a determination is made as to whether or the processing on all phonemes in the breath group has been finished. When the pause at the end of the breath group is reached after the processing on all phonemes in the breath group is executed, the length of the pause is set to a fixed multiple in accordance with the speech speed in step S509. In step S510, a determination is made as to whether or not the processing is completed. Until the processing on all data is completed, the processing from steps S503 to S510 is repeated. After the processing of all data is completed, the length of an entire sentence is calculated in step S511. In step S512, the phoneme lengths of all phonemes in the sentence are proportionally adjusted so that the length of the entire sentence, i.e., the amount of read-aloud time, has a predetermined length, for example, a length that is the same as or similar to the length when the phoneme lengths are not increased. After the completion of the processing, speech synthesis is executed in step S513 and speech is output.

As described above, the first phoneme in each breath group is adjusted in accordance with the speech speed, that is, the phoneme length of a phoneme immediately after a pause is adjusted to, for example, 1.5 times, whereas the phoneme lengths of all phonemes in a sentence are proportionally reduced by an amount corresponding to the increase in the phoneme length of the first phoneme. This arrangement enhances ease of hearing synthesized speech while maintaining the length of the breath group and improves recognition of read-aloud text converted into speech.

### Sixth Embodiment

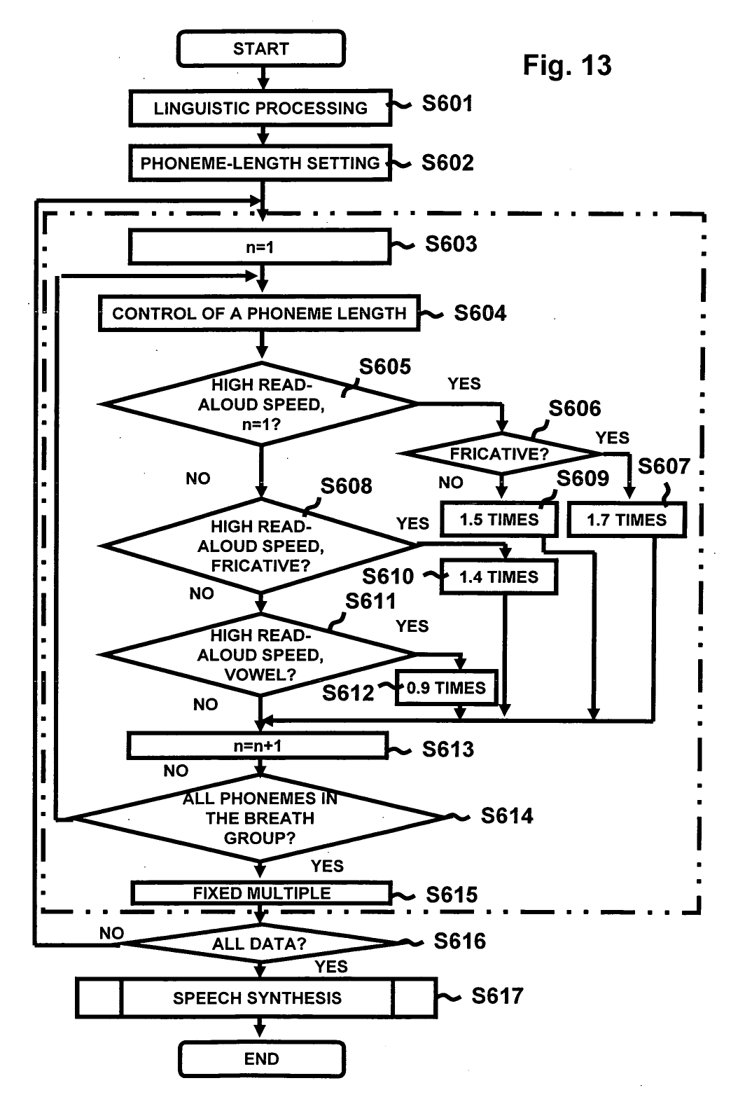

A sixth embodiment of the present invention will now be described with reference to FIG. 13. FIG. 13 is a flowchart showing one example of a processing procedure for controlling phoneme lengths according to a sixth embodiment.

This processing procedure is one example of a program or method for text-to-speech read-aloud, and is executed using the text-to-speech read-aloud device 2 (FIG. 1) and the phoneme-length controller 18 (FIG. 2). The sixth embodiment employs both the phoneme-length adjustment in the second embodiment (FIG. 7) and the phoneme-length adjustment in the third embodiment (FIG. 8). That is, relative to an increase in the phoneme length of a phoneme at a speech head or a fricative, the phoneme length of another phoneme, for example, the phoneme length of a vowel is reduced. This arrangement can enhance ease of hearing without an e increase in the amount of time for converting read-aloud text into speech.

In this processing procedure, as shown in FIG. 13, in step S601, linguistic processing is executed, and in step S602, phoneme-length setting processing is executed. As processing for phonemes in a breath group, in step S603, a phoneme number n is initialized (n=1), and in steps S603 to S616, control of the phoneme length is performed in accordance with the speech speed. The phoneme-length control is performed for each breath group, as in the second embodiment (FIG. 7).

In the sixth embodiment, in step S604, the phoneme length is set to a fixed multiple corresponding to the speech speed. In step S605, a determination is made as to whether or not the speech speed is high read-aloud speed and whether or not the phoneme is the first phoneme (n=1). When the speech speed is high read-aloud speed and the phoneme is the first phoneme (n=1; i.e., Yes in step S605), in step S606, a determination is made as to whether or not the phoneme is fricative. When the speech speed is high read-aloud speed and the phoneme is the first phoneme (n=1) and a fricative (Yes in step S606), the phoneme length is set or adjusted to a predetermined multiple α (e.g., α=1.7) in step S607. When the phoneme is neither the first phoneme (n=1) nor a fricative (No in step S608), the phoneme length is not adjusted. That is, in this case, the state in which the phoneme length was set to the fixed multiple in step S604 is maintained.

When the speech speed is high read-aloud speed and the phoneme is the first phoneme (No in step S606), the phoneme length is set or adjusted to a predetermined multiple β (e.g., β=1.5) in step S609. When the speech speed is high read-aloud speed and the phoneme is a fricative (Yes in step S608), the phoneme length is set or adjusted to a predetermined multiple γ (e.g., γ=1.4) in step S610.

Thus, when the speech speed is high read-aloud speed and the phoneme is the first phoneme and a fricative, when the speech speed is high read-aloud speed and the phoneme is the first phoneme, when the speech speed is high read-aloud speed and the phoneme is a fricative, or when the phoneme is neither the first phoneme nor a fricative, the phoneme length thereof is adjusted or not adjusted as shown in table 1 illustrated above.

After such processing, in step S611, a determination is made as to whether or not the speech speed is high read-aloud speed and the phoneme is a vowel,. When the speech speed is high read-aloud speed and a vowel (Yes in step S611), the phoneme length thereof is set or adjusted to a predetermined multiple, for example, 0.9 times, in step S612. When the phoneme is not a vowel (No in step S611), the phoneme length is not adjusted.

Thereafter, in step S613, the phoneme number n is updated (n=n+1), as described above. In step S614, a determination is made as to whether or not the processing on all phonemes in the breath group is completed. When the pause at the end of the breath group is reached, the length of the pause is set to a fixed multiple in accordance with the speech speed in step S615. In step S616, a determination is made as to whether or not all data is processed. In step S617, speech synthesis is executed.

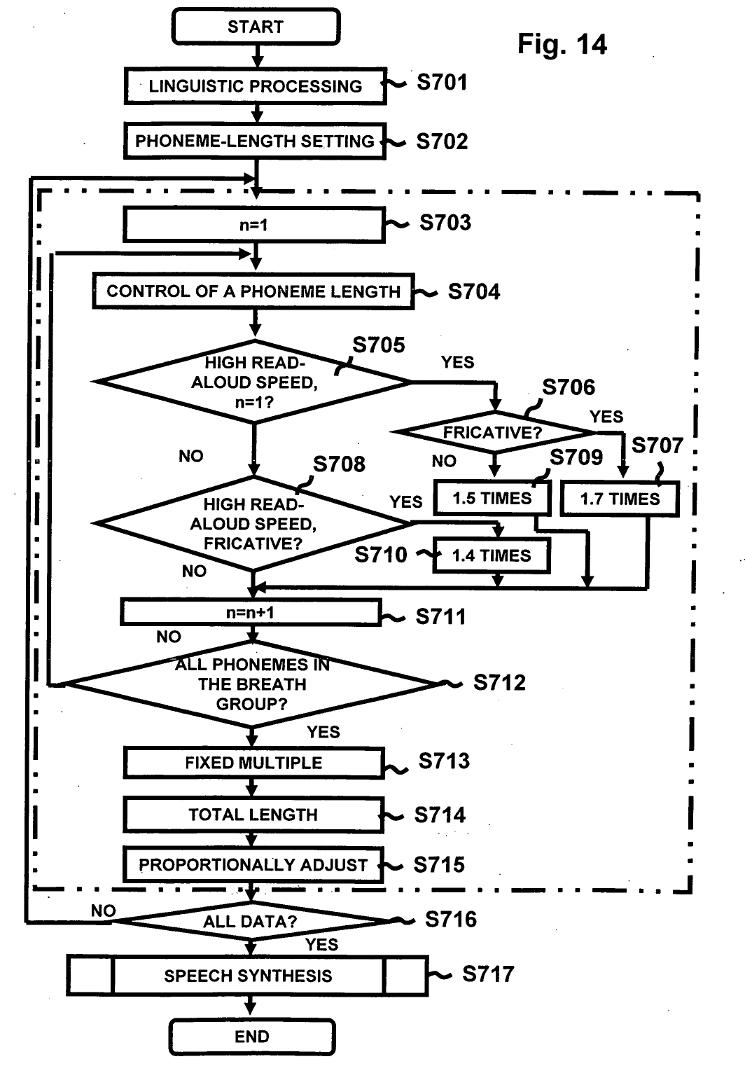

As described above, the first phoneme and a fricative in each breath group are adjusted in accordance with a speech speed. Thus, when a phoneme in question is a phoneme immediately after a pause and/or a fricative or when the phoneme in question is neither thereof, the amount of increase in the phoneme length of the phoneme in question is varied. When the phoneme is a vowel, the phoneme length thereof is reduced as described above. As a result, the increased amount of time for the phoneme length of the phoneme after the pause or the fricative is complemented by an amount corresponding to the reduction in the phoneme length of the vowel. This arrangement enhances ease of hearing synthesized speech and improves recognition of read-aloud text converted into the speech without an increase in the amount of entire reproduction time for speech output, while maintaining the entire length. Seventh Embodiment A seventh embodiment of the present invention will now be described with reference to FIG. 14. FIG. 14 is a flowchart showing one example of a processing procedure for controlling phoneme lengths according to a seventh embodiment.

This processing procedure is one example of a program or method for text-to-speech read-aloud, and is executed using the text-to-speech read-aloud device 2 (FIG. 1) and the phoneme-length controller 18 (FIG. 2). In the present embodiment, in addition to the adjustment of phoneme lengths in the second embodiment (FIG. 7), i.e., relative to the increase in the phoneme lengths of a speech head and a fricative, other phoneme lengths, including a pause, are reduced by an amount corresponding to the increase in the phoneme lengths. That is, the phoneme lengths of phonemes in each breath group are proportionally reduced by an amount corresponding to the increase in the phoneme lengths of the speech head and the fricative, to thereby enhance ease of hearing while maintaining the length of the breath group without an increase in the amount of time for converting read-aloud text into speech.

In the seventh embodiment, the phoneme-length adjusting unit 24 in the phoneme-length controller 18 has the breath-group-length calculating unit 30, as in the fourth embodiment (FIG. 9). Thus, the breath-group-length calculating unit 30 calculates a total length of a breath group, based on an output from the phoneme-length adjusting unit 24. The phoneme-length adjusting unit 24 has a function for performing control so that the amount of time for reading aloud the breath group has a predetermined value by proportionally reducing the phoneme lengths of all phonemes in the breath group by an amount corresponding to increases in the phoneme lengths of specific phonemes, specifically in this case, the phoneme lengths of the first phoneme and a fricative.

In this processing procedure, as shown in FIG. 14, in step S701, linguistic processing is executed, and in step S702, phoneme-length setting processing is executed. As processing for phonemes in a breath group, in step S703, a phoneme number n is initialized (n=1), and in steps S703 to S716, control of the phoneme length is performed in accordance with the speech speed. The phoneme-length control is performed for each breath group, as in the second embodiment (FIG. 7).

In the seventh embodiment, in step S704, the phoneme length is set to a fixed multiple corresponding to the speech speed. In step S705, a determination is made as to whether or not the speech speed is high read-aloud speed and whether or not the phoneme is the first phoneme (n=1). When the speech speed is high read-aloud speed and the phoneme is the first phoneme (n=1; i.e., Yes in step S705), in step S706, a determination is made as to whether or not the phoneme is fricative. When the speech speed is high read-aloud speed and the phoneme is the first phoneme (n=1) and a fricative (Yes in step S706), the phoneme length is set or adjusted to a predetermined multiple α (e.g., α=1.7) in step S707. When the phoneme is neither the first phoneme (n=1) nor a fricative (No in step S708), the phoneme length is not adjusted. That is, in this case, the state in which the phoneme length was set to the fixed multiple in step S704 is maintained.

When the speech speed is high read-aloud speed and the phoneme is the first phoneme (No in step S706), the phoneme length is set or adjusted to a predetermined multiple β (e.g., β=1.5) in step S709. When the speech speed is high read-aloud speed and the phoneme is a fricative (Yes in step S708), the phoneme length is set or adjusted to a predetermined multiple γ (e.g., γ=1.4) in step S710.

Thus, when the speech speed is high read-aloud speed and the phoneme is the first phoneme and a fricative, when the speech speed is high read-aloud speed and the phoneme is the first phoneme, when the speech speed is high read-aloud speed and the phoneme is a fricative, or when the phoneme is neither the first phoneme nor a fricative, the phoneme length thereof is adjusted or not adjusted as shown in table 1 illustrated above.

After such processing, in step S711, the phoneme number n is updated (n=n+1). In step S712, a determination is made as to whether or not the processing on all phonemes in the breath group is completed. When the pause at the end of the breath group is reached, the length of the pause is set to a fixed multiple in accordance with the speech speed in step S713. Thereafter, in step S714, the length of the entire breath group is calculated. In step S715, the phoneme lengths of all phonemes are proportionally adjusted so that the length of the breath group becomes a predetermined length, for example, a length that is the same as or similar to the length when the phoneme lengths are not increased. In step S716, a determination is made as to whether or not all data is processed. Until the processing on all data is completed, the processing from steps S703 to S716 is repeated. After the completion determination, speech synthesis is executed in step S717 and speech is output.

As described above, the first phoneme and a fricative in each breath group are adjusted in accordance with a speech speed. Thus, when a phoneme in question is a phoneme immediately after a pause and/or a fricative or when the phoneme in question is neither thereof, the amount of increase in the phoneme length of the phoneme in question is varied, as described above, and phonemes in the breath group are proportionally reduced by an amount corresponding to the increases in the phoneme lengths of the phonemes. This arrangement enhances ease of hearing synthesized speech and improves recognition of read-aloud text converted into the speech, while maintaining the length of the breath group.

### Eighth Embodiment

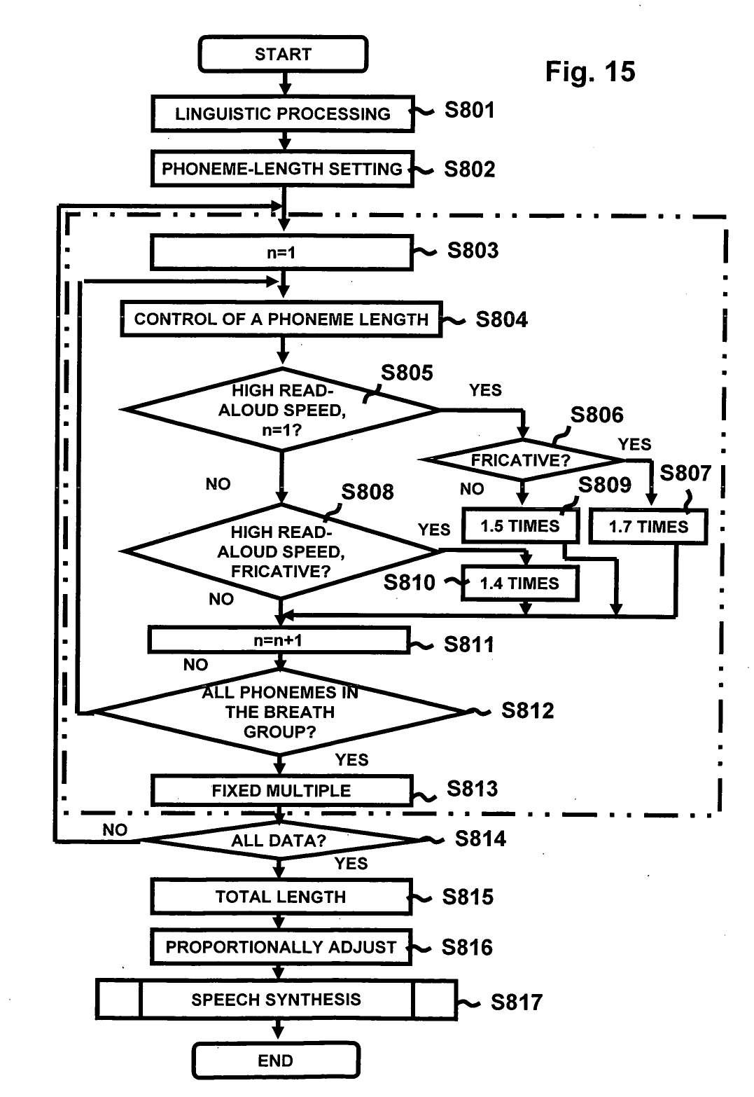

An eighth embodiment of the present invention will now be described with reference to FIG. 15. FIG. 15 is a flowchart showing one example of a processing procedure for controlling phoneme lengths according to an eighth embodiment.

This processing procedure is one example of a program or method for text-to-speech read-aloud, and is executed using the text-to-speech read-aloud device 2 (FIG. 1). In the eighth embodiment, in addition to the adjustment of phoneme lengths in the second embodiment (FIG. 7), i.e., relative to the increases in the phoneme lengths of the first phoneme and a fricative phoneme), the phoneme lengths of phonemes in the entire sentence are proportionally reduced by an amount corresponding to the increases in the phoneme lengths, to thereby enhance ease of hearing while maintaining the length of the entire sentence without an increase in the amount of time for converting read-aloud text into speech.

In the eighth embodiment, the phoneme-length controller 18 in the text-to-speech read-aloud device 2 (FIG. 1) has an entire-sentence-length calculating unit 32, as in the fifth embodiment (FIG. 11). The entire-sentence-length calculating unit 32 calculates a total length of a sentence, based on an output from the phoneme-length adjusting unit 24. A, result of the calculation is sent to the phoneme-length adjusting unit 24 as control information. In this case, the phoneme-length adjusting unit 24 has a function for performing control so that the amount of time for reading aloud the sentence has a predetermined value by proportionally reducing the phoneme lengths of all phonemes in the sentence by an amount corresponding to increases in the phoneme lengths of specific phonemes, specifically in this case, the phoneme lengths of the first phoneme and a fricative phoneme.

In this processing procedure, as shown in FIG. 15, in step S801, linguistic processing is executed, and in step S802, phoneme-length setting processing is executed. As processing for phonemes in a breath group, in step S803, a phoneme number n is initialized (n=1), and in steps S803 to S816, control of the phoneme length is performed in accordance with the speech speed. The phoneme-length control is performed for each breath group, as in the second embodiment (FIG. 7).

In the eighth embodiment, in step S804, the phoneme length is set to a fixed multiple corresponding to the speech speed. In step S805, a determination is made as to whether or not the speech speed is high read-aloud speed and whether or not the phoneme is the first phoneme (n=1). When the speech speed is high read-aloud speed and the phoneme is the first phoneme (n=1; i.e., Yes in step S805), in step S806, a determination is made as to whether or not the phoneme is fricative. When the speech speed is high read-aloud speed and the phoneme is the first phoneme (n=1) and a fricative (Yes in step S806), the phoneme length is set or adjusted to a predetermined multiple α (e.g., α=1.7) in step S807. When the phoneme is neither the first phoneme (n=1) nor a fricative (No in step S808), the phoneme length is not adjusted. That is, in this case, the state in which the phoneme length was set to the fixed multiple in step S804 is maintained.

When the speech speed is high read-aloud speed and the phoneme is the first phoneme (No in step S806), the phoneme length is set or adjusted to a predetermined multiple β (e.g., β=1.5) in step S809. When the speech speed is high read-aloud speed and the phoneme is a fricative (Yes in step S808), the phoneme length is set to a predetermined multiple γ (e.g., γ=1.4) in step S810.

Thus, when the speech speed is high read-aloud speed and the phoneme is the first phoneme and a fricative, when the speech speed is high read-aloud speed and the phoneme is the first phoneme, when the speech speed is high read-aloud speed and the phoneme is a fricative, or when the phoneme is neither the first phoneme nor a fricative, the phoneme length thereof is adjusted or not adjusted as shown in table 1 illustrated above.

After such processing, in step S811, the phoneme number n is updated (n=n+1). In step S812, a determination is made as to whether or not the processing on all phonemes in the breath group is completed. When the pause at the end of the breath group is reached, the length of the pause is set to a fixed multiple in accordance with the speech speed in step S813. In step S814, a determination is made as to whether or not all data is processed.

After the processing of all data is completed, the length of an entire sentence is calculated in step S815. In step S816, the phoneme lengths of all phonemes in the sentence are proportionally adjusted so that the length of the entire sentence, i.e., the amount of read-aloud time, has a predetermined length, for example, a length that is the same as or similar to the length when the phoneme lengths are not increased. After the completion of the processing, speech synthesis is executed in step S817 and speech is output.

As described above, the first phoneme and a fricative in each breath group are adjusted in accordance with a speech speed. Thus, when a phoneme in question is a phoneme immediately after a pause and/or a fricative or when the phoneme in question is neither thereof, the amount of increase in the phoneme length of the phoneme in question is varied, as described above, and all phonemes in the sentence are proportionally reduced by an amount corresponding to the increases in the phoneme lengths. This arrangement enhances ease of hearing synthesized speech and improves recognition of read-aloud text converted into the speech, while maintaining the length of the entire sentence.

### Ninth Embodiment

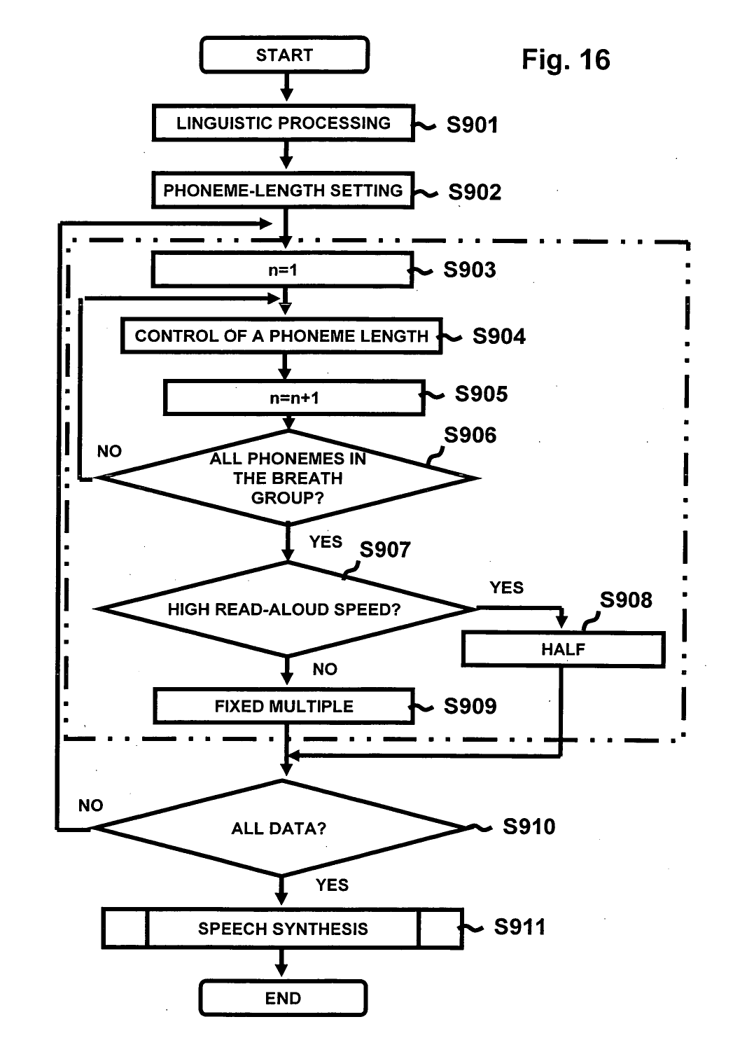

A ninth embodiment of the present invention will now be described with reference to FIG. 16. FIG. 16 is a flowchart showing one example of a processing procedure for controlling phoneme lengths according to a ninth embodiment.

This processing procedure is one example of a program or method for text-to-speech read-aloud, and is executed using the text-to-speech read-aloud device 2 (FIG. 1) and the phoneme-length controller 18 (FIG. 2). In this embodiment, the length of a pause is reduced when the speech speed is high to reduce the length of the amount of read-aloud time with substantially the same ease of hearing. When the speech speed is assumed to be the 3× speed and a pause length is set to half in reverse proportion to the speech speed, the pause length becomes ⅙ of the pause length at the normal speech speed. Thus, the reduction in the pause length can reduce the amount of read-aloud time.

In the processing procedure, as shown in FIG. 16, in step S901, linguistic processing is performed, and in step S902, phoneme-length setting processing is executed. As processing for phonemes in a breath group, in step S903, a phoneme number n is initialized (n=1), and in steps S903 to S910, control of the phoneme length is performed in accordance with the speech speed. The phoneme-length control is performed for each breath group, as in the first embodiment (FIG. 5).

In the ninth embodiment, in step S904, the phoneme length is set to a fixed multiple corresponding to the speech speed. In step S905, the phoneme number n is updated (n=n+1). In step S906, a determination is made as to whether or not the processing on all phonemes in the breath group is completed.

In this case, in step S907, a determination is made as to whether or not the speech speed is high. When the speech speed is high (Yes in step S907), in step S908, the length of the pause at the end of the breath group is set to a predetermined multiple, for example, one half, relative to the fixed multiple.

When the speech speed is not high (No in step S907), the length of the pause when the pause at the end of the breath group is reached is set to a fixed multiple according to the speech speed in step S909. In step S910, a determination is made as to whether or not a determination is made as to whether or not processing on all data is completed. After processing on all data is completed, speech synthesis is executed in step S911 and speech is output.

As described above, the length of the pause at the end of a breath group is reduced during high-speed read-aloud, to thereby maintain the amount of time for reading the entire length, enhance ease of hearing synthesized speech, and improve recognition of read-aloud text converted into the speech.

### Tenth Embodiment

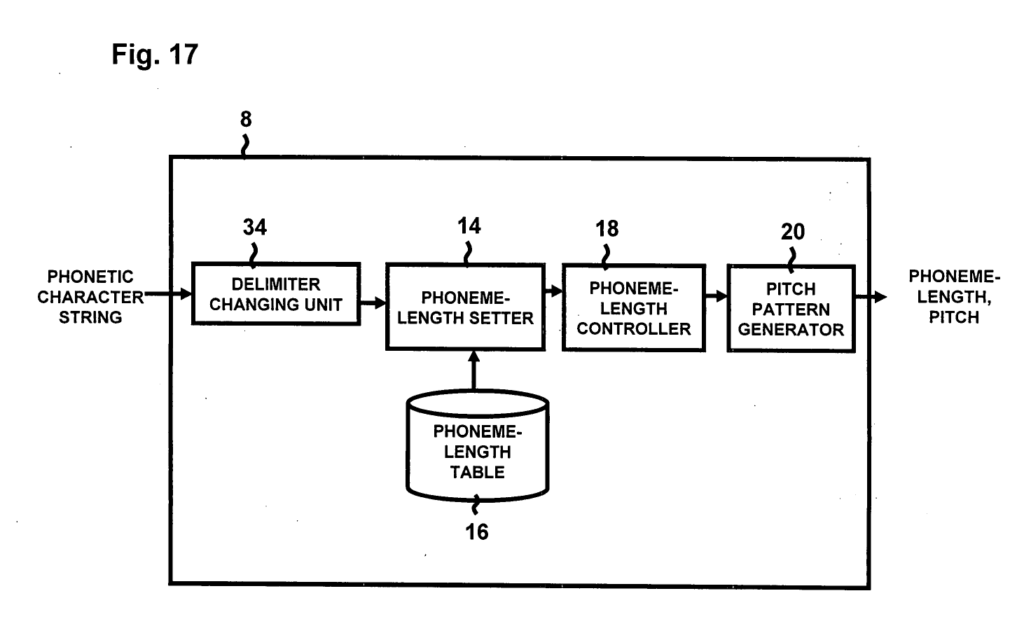

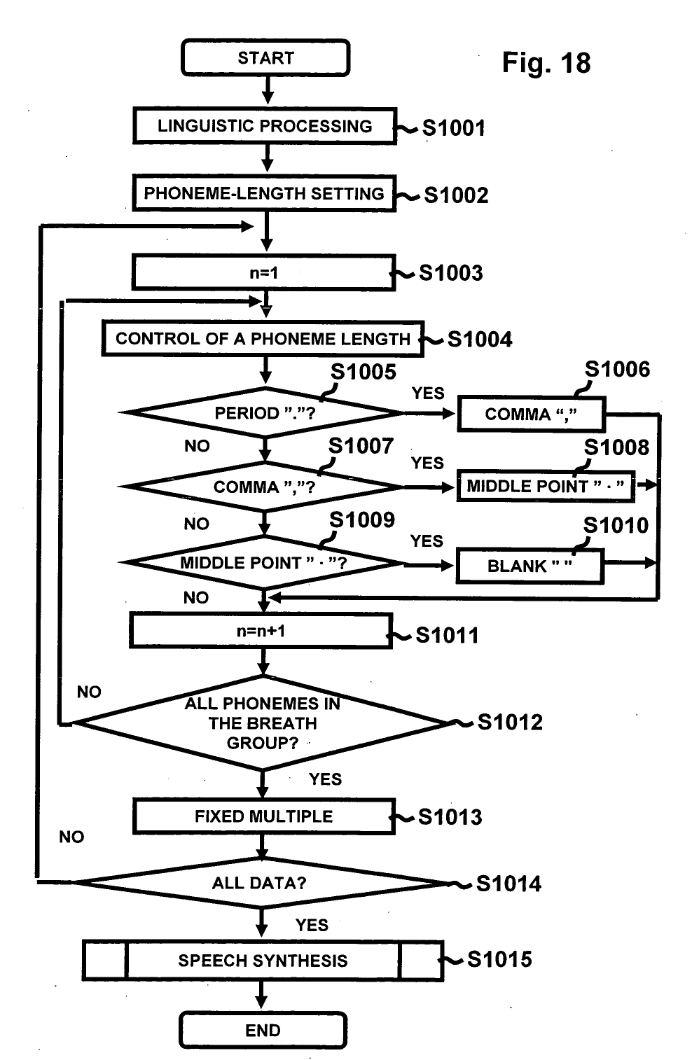

A tenth embodiment of the present invention will now be described with reference to FIGS. 17 and 18. FIG. 17 is a block diagram showing another example of the configuration of the parameter generator 8 in the text-to-speech read-aloud device 2 according to a tenth embodiment. FIG. 18 is a flowchart showing one example of a processing procedure for phoneme-length control according to the tenth embodiment. In FIG. 17, same units as those in FIG. 1 are denoted by the same reference numerals.

In the tenth embodiment, in the parameter generator 8, a delimiter changing unit 34 is provided at a stage prior to the phoneme-length setter 14. The delimiter changing unit 34 changes the length of a pause at a delimiter in a breath group containing a phonetic character string generated by the linguistic processor 4 (FIG. 1). Provision of the delimiter changing unit 34 makes it possible to reduce the amount of time for reproducing an entire sentence to be read aloud while securing the phoneme lengths.

In this case, when the phonetic character string resulting from the linguistic processing is assumed to be “yamanashi'ken no koukou wo so tsugyoshi te, shinyou ki'n koni ha*itte yonen me'desu.”, the delimiter changing unit 34 reduces the lengths of breath-group delimiters by one step. Specifically, a middle point “.” having a small pause length is changed to an accent-delimitated blank (without a pause), a comma “,” having a medium pause length is changed to a middle point “.” having a small pause length, and a period “.” having a large pause length is changed to a comma “,” having a medium pause length.

Consequently, the phonetic character string is changed to “yamanashi'ken no koukou wo so tsugyoshi te.shinyou ki'n koni ha*itte yonen me'desu,”, so that the total amount of time for reproducing the read-aloud text can be reduced.

In the processing procedure, as shown in FIG. 18, in step S1001, linguistic processing is executed, and in step S1002, phoneme-length setting processing is executed. As processing for phonemes in a breath group, in step S1003, a phoneme number n is initialized (n=1), and in steps S1003 to S1014, control of the phoneme length is performed in accordance with the speech speed. The phoneme-length control is performed for each breath group, as in the first embodiment (FIG. 6).

In the tenth embodiment, in step S1004, the phoneme length is set to a fixed multiple in accordance with the speech speed. After the setting of the phoneme length, in step S1005, a determination is made as to whether or not the character is a period “.”. When the character is a period “.”, the character is replaced with a comma “,” in step S1006 and the process proceeds to step S1011.

When the character is not a period “.” (No in step S1005), a determination is made as to whether or not the character is a comma “,” in step S1007. When the character is a comma “,”, the character is replaced with a middle point “.” in step S1008 and the process proceeds to step S1011.

When the character is not a comma “,” (No in step S1007), a determination is made as to whether or not the character is a middle point “.” in step S1009. When the character is a middle point “.”, the character is replaced with a blank “ ” in step S1010 and the process proceeds to step S1011.

In the processing procedure, in step S1011, the phoneme number n is updated (n=n+1). In step S1012, a determination is made as to whether or not the processing on all phonemes in the breath group is completed. When the pause at the end of the breath group is reached, the length of the pause is set to a fixed multiple in accordance with the speech speed in step S1013. In step S1014, a determination is made as to whether or not the processing on all data is completed. In step S1015, speech synthesis is executed.

In the processing procedure, characters representing breath group delimiters are replaced to reduce the lengths of the delimiters by one step. Specifically, a middle point “.” having a small pause length (e.g., 0.1 second at the normal speech speed) is changed to an accent-delimitated blank (without a pause), a comma “,” having a medium pause length (e.g., 0.3 second at the normal speech speed) is changed to a middle point “.” having a small pause length, and a period “.” having a large pause length (e.g., 0.8 second at the normal speech speed) is changed to a comma “,”, having a medium pause length. Thus, the phonetic character string is changed to “yamanashi'ken no koukou wo so tsugyoshi te.shinyou ki'n koni ha*itte yonen me'desu,”. As a result of such change, the total amount of reproduction time can be reduced.

Thus, the phoneme lengths in each breath group are secured and the total amount of time for reproducing a read-aloud sentence can be reduced.

### Other Embodiments

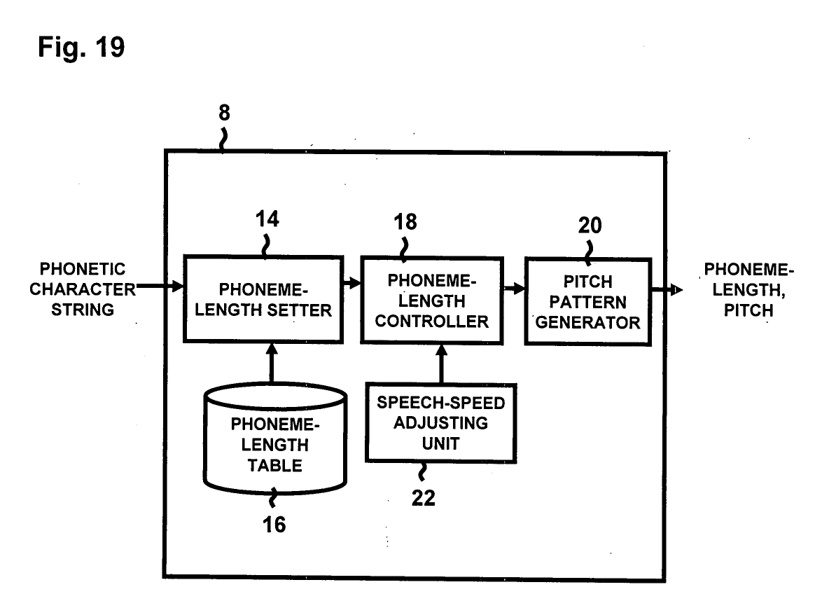

(1) Speech-speed information input to the phoneme-length controller 18 will now be described with reference to FIG. 19. FIG. 19 is a block diagram showing a parameter generator that includes a speech-speed adjusting unit. Although the speech-speed information is input to the phoneme-length controller 18 in the above-described embodiments, a speech-speed adjusting unit 22 that allows the speech speed to be externally adjusted (set) may be provided in the parameter generator 8, as shown in FIG. 19.

(2) Although cases in which the phoneme length of a phoneme immediately after a pause is increased have been described in the above embodiments, the present invention is also applicable to a case in which the phoneme length is reduced.

(3) Although the mobile terminal device 200 (FIGS. 3 and 4) has been illustrated in the first embodiment, the present invention is not limited to the embodiments described above. For example, the present invention is also applicable to various types of equipment, such as a portable digital assistant (PDA), electronic equipment that incorporates a computer (such as a personal computer) and that outputs sound, and equipment that incorporates an electronic device unit.

(4) When the read-aloud speed is high in the above embodiments, some or all pauses in character data may be removed. The pause removal allows the amount of reproduction time to be reduced without compromising ease of hearing.

(5) When the read-aloud speed is low, the phoneme length of a phoneme immediately after a pause may be reduced or may be adjusted to have the same length as a reference speed.

(6) In the above-described sixth embodiment (FIG. 13), when the read-aloud speed is high, the length of a vowel, as another phoneme, is reduce relative to an increase in the phoneme length of the first phoneme and the length of a fricative. However, relative an increase in the length of a specific pause or the phoneme length of a phoneme, another phoneme length may be reduced. Such an arrangement can also increase the amount of read-aloud time.

(7) Although the processing is performed for each breath group in the above-described tenth embodiment (FIG. 18), the processing may be performed for each sentence, other than a breath group, or may be performed for a phrase in a specific sentence.

(8) Although a fricative is used as an example of a specific phoneme in the second, sixth, seventh, and eighth embodiments and the phoneme length of the fricative is increased, the increase in the length of the fricative may be eliminated or the length of another phoneme other than a fricative may be increased.

### EXAMPLES

### First Example

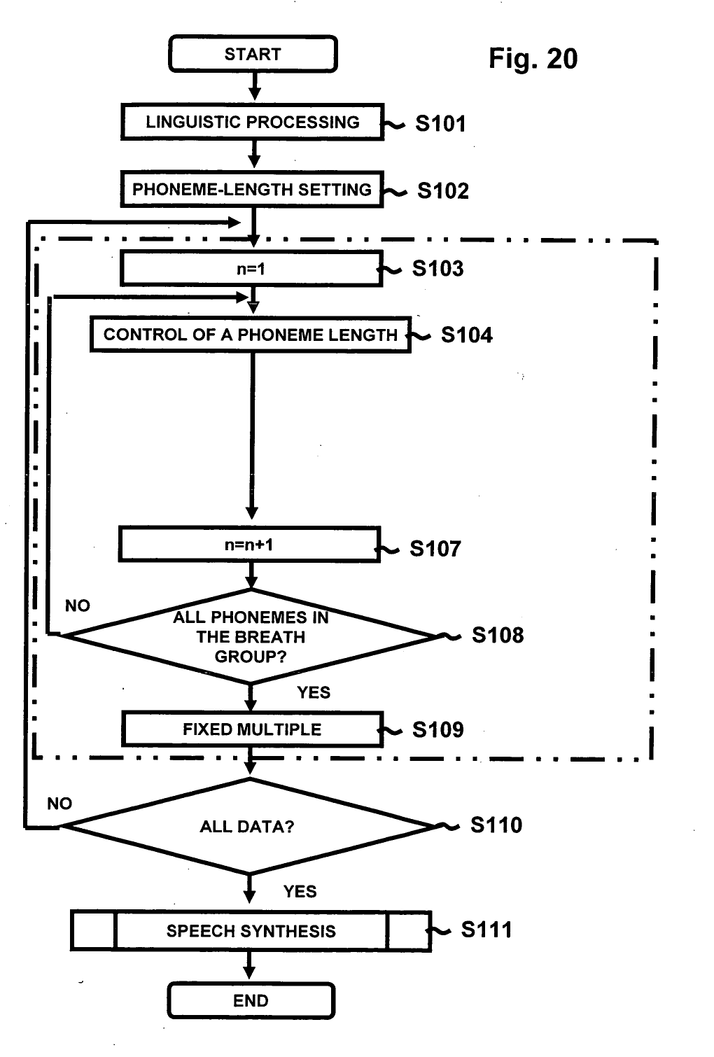

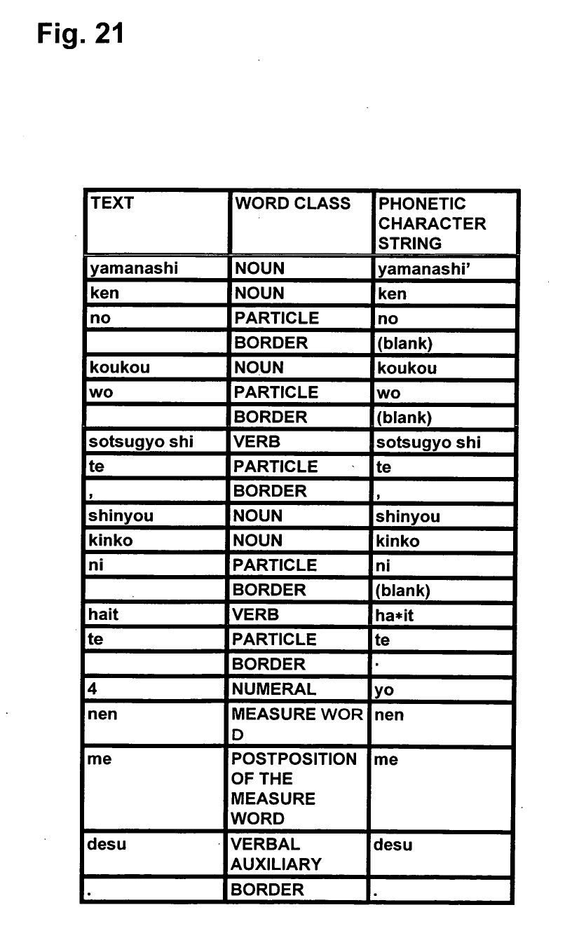

A first example will now be described with reference to FIGS. 20 and 21. FIG. 20 is a flowchart showing a comparative example relative to the flowchart shown in FIG. 6. FIG. 21 is a result of the linguistic processing.

When the phoneme length of each phoneme is to be increased in accordance with the speech speed, the text-to-speech read-aloud device 2 (FIG. 1) performs the processing in the flowchart shown in FIG. 20. In this case, FIG. 20 shows processing when the length of a speech head immediately after a pause is not adjusted. The same steps as those in the flowchart shown in FIG. 6 are denoted by the same reference numerals. That is, the processing in the flowchart shown in FIG. 20 does not include the processing in steps S105 and S106 in the flowchart shown in FIG. 6. In this processing, the phoneme length of the first phoneme is not increased during high-speed read-aloud and the phoneme length is set to a fixed multiple in inverse proportion to the high-speed read-aloud.

In the processing, when the input text is, for example, “yamanashiken no koukou wo so tsugyoshi te shinyou kin koni haitte 4nen me desu.” (FIG. 5), the result of the word analysis can be expressed by input text, parses, and phonetic character strings, as shown in FIG. 21.

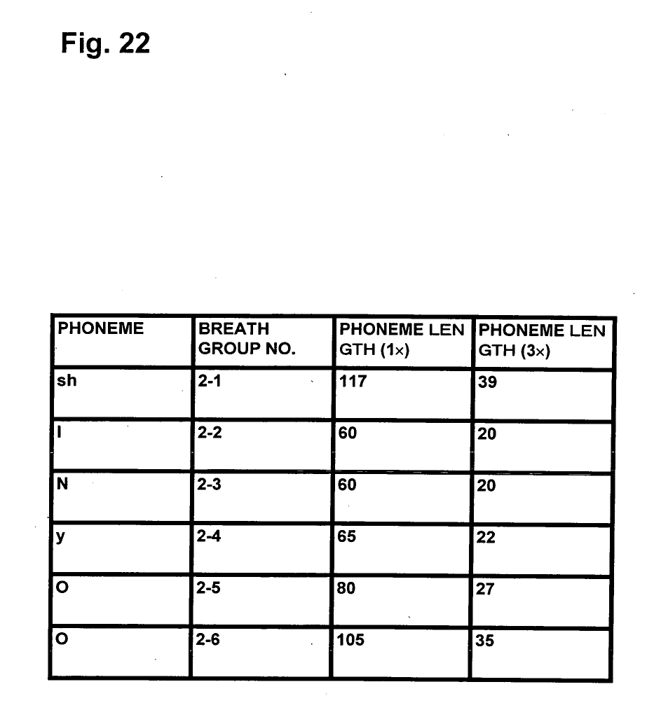

In this exemplary text “yamanashi ken no koukou wo so tsugyoshi te shinyou kin koni haitte 4nen me desu.”, “yamanashi'”, is a noun, a phonetic character string thereof is “yamanashi'”, “ken” is a noun, a phonetic character string thereof is “ken”, “no” is a particle, a phonetic character thereof is “no”, and a portion subsequent to the “no” is a accent-phrase border and is thus a blank. Further, “koukou” is a noun, a phonetic character string thereof is “koukou”, “wo” is a particle, a phonetic character string thereof is “wo”, and a portion subsequent thereto is an accent-phrase border and is thus a blank. “sotsugyo shi” is a verb and a phonetic character string thereof is “sotsugyo shi”, “te” is a particle, a phonetic character string thereof is “te”, “,” is a breath group border (having a medium pause length), a phonetic character string thereof is “,”, “shinyo” is a noun, and a phonetic character string thereof is “shinyo”, “kinko” is a noun, a phonetic character string thereof is “ki'nko”, “ni” is a particle”, a phonetic character string thereof is “ni”, and a portion subsequent thereto is an accent-phrase border and is thus a blank. Further, “hait” is a verb, a phonetic character string thereof is “ha*it”, “te” is a particle, a phonetic character string thereof is “.”, “4” is at numeral, a phonetic character string thereof is “yo”, “nen” is a measure word, a phonetic character string thereof is “nen”, “me” is a postposition of the measure word, a phonetic character string thereof is “me'”, “desu” is a verbal auxiliary, a phonetic character string thereof is “desu”, “.” is a breath-group border (having a large pause length), and a phonetic character string thereof is “.”. Thus, a phonetic character string of the above-noted exemplary text is expressed by “yamanashi'ken no koukou wo so tsugyoshi te, shinyou ki'n koni ha*itte yonen me'desu”. In FIG. 21, the input text and phonetic character strings are written by using Roman characters, but the input text is different from phonetic character strings as data. In other words, the text-to-speech read-aloud device 2 transforms the input text into phonetic character strings. Modification of the phoneme lengths of the portion “shinyou” in the phonetic character string and the modification of phoneme lengths according to a speech speed will now be described with reference to FIG. 22. FIG. 22 is an example of generated phoneme lengths in this case.

In this example, when seven moras per second is assumed to be a reference (1×) speed and about 21 moras per second (i.e., the 3× speech speed) are to be generated, the phoneme lengths for the 1× speed are read from the phoneme-length table 16 (FIG. 1) and are modified in reverse proportion to the speech speed. After the modification, a pitch pattern is generated based on information, such as accents, to synthesize a speech waveform.

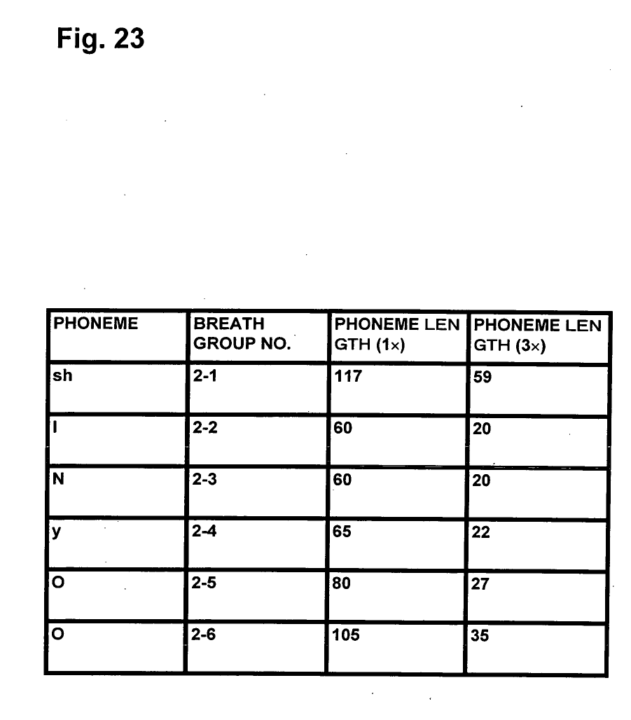

In contrast, a result of the processing in the first embodiment (FIG. 6) will now be described with reference to FIG. 23. FIG. 23 is a table showing an example of generating phoneme lengths according to the first embodiment (FIG. 6).

When a phoneme length is to be generated at the 3× speed, the length of phoneme “Sh”, which is a speech head subsequent to the pause, is set to 1.5 times the phoneme length obtained from simple inverse proportion. As a result, the phoneme length at the reference (1×) speed is 117 ms, whereas the phoneme length at the 3× speed is 59 ms. Comparison of these phoneme lengths with those of other phonemes “I”, “N”, “y”, “O”, and “O” shows that the phoneme length “117 ms” of phoneme “sh” at the 1× speed is not prominently different from the phoneme lengths of the other phonemes, specifically, the length of phoneme “I”=60 ms, the length of phoneme “N”=60 ms, the length of phoneme “y”=65 ms, the length of phoneme “O”=80 ms, and the length of phoneme “O”=105 ms. In contrast, the phoneme length “59 ms” of phoneme “sh” at the 3× speed is prominently different from the phoneme lengths of the other phonemes, specifically, the length of phoneme “I”=20 ms, the length of phoneme “N”=20 ms, the length of phoneme “y”=22 ms, the length of phoneme “O”=27 ms, and the length of phoneme “O”=35 ms. As a result, it is possible to improve the ease of auditory hearing and also can enhance recognition.

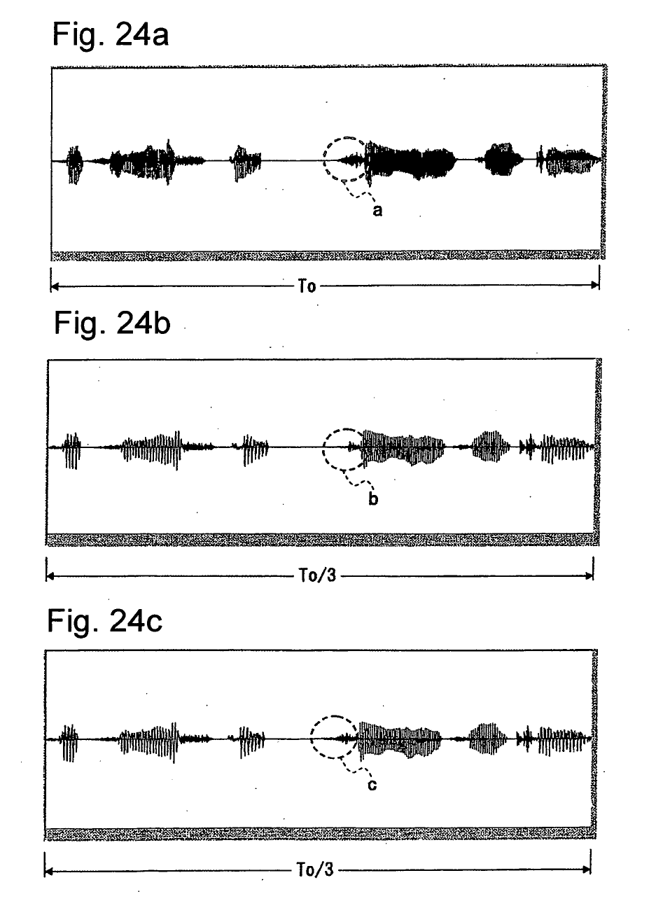

Speech-synthesis waveforms resulting from the above-described processing will now be described with reference to FIG. 24. FIG. 24a, represents a speech-synthesis waveform when “so tsugyoshi te shinyou kin koni” is read aloud at a normal speed in accordance with the processing shown in FIG. 20. FIG. 24b represents a waveform obtained when the same sentence is uniformly read aloud at a high speed in accordance with the processing in the flowchart shown in FIG. 20. That is, waveform B is obtained when the phoneme length of a speech head immediately after a pause is not increased. Reference character C represents a speech-synthesis waveform obtained when the processing (the flowchart shown in FIG. 6) in the first embodiment is used to increase the phoneme length of a speech head. The speech speed for the read-aloud time for waveforms FIG. 24b and 24c is set to three times the speech speed for the read-aloud time for waveform A. Thus, in waveforms in FIG. 24a, 24b and 24c, the amount of read-aloud time of waveforms in FIG. 24b and 24c which is reduced to To/3, where To is the amount of read-aloud time of waveform in FIG. 24a, is illustrated with the same scale as the read-aloud time of waveform in FIG. 24a.

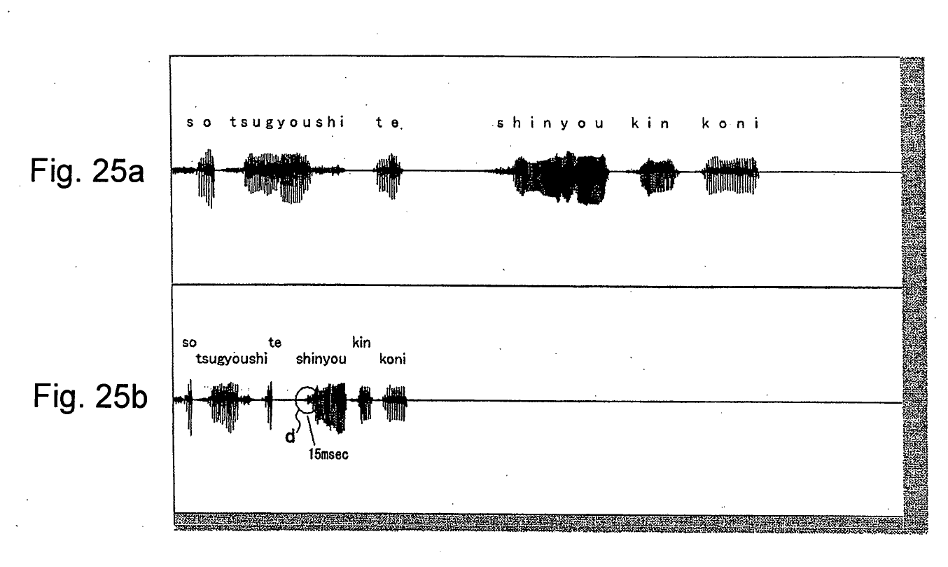

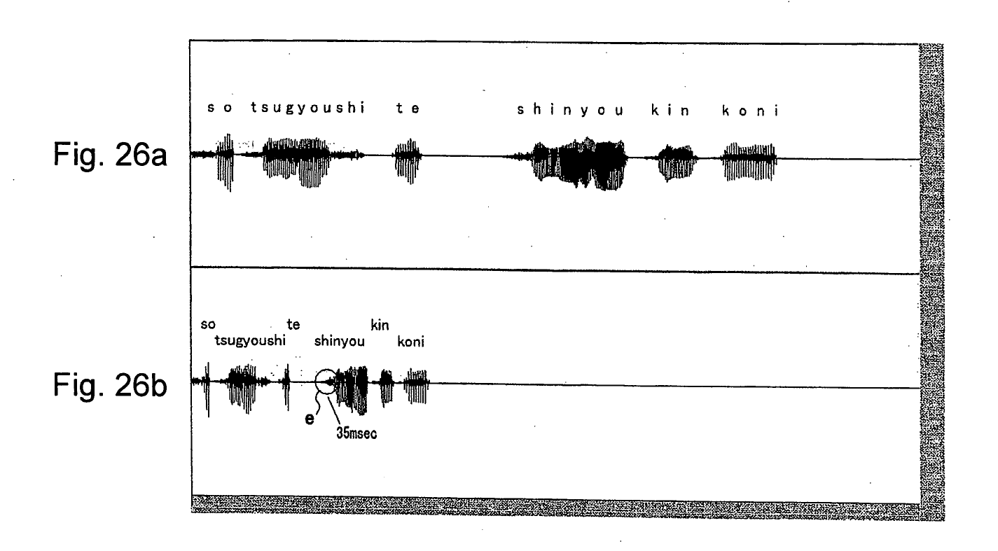

A dotted-line-surrounded portion a in waveform in FIG. 24a indicates the phoneme at a speech head immediately after a pause and a dotted-line surrounded portion b in waveform B indicates the same phoneme. It can be understood that the phoneme length of the phoneme b is reduced by an amount corresponding to the three-fold speech speed. It was confirmed that, when such read-aloud sound is heard, it sounds like sound dropout, which makes it difficult to hear the speech head. In contrast, in a dotted-line-surrounded portion c in waveform C, the phoneme length of the phoneme at speech head is increased relative to the three-fold speech speed. Thus, even when read-aloud sound is heard, no sound dropout occurs and ease of hearing is thus enhanced. Second example Waveforms resulting from processing according to a second example will now be described with reference to FIGS. 25 and 26. FIG. 25 shows speech-synthesis waveforms of a comparative example, and FIG. 26 shows speech-synthesis waveforms according to a second example. FIG. 25a represents a waveform obtained at the normal read-aloud speed, and B represents a waveform obtained at the high read-aloud speed. Compared to the normal-speed read-aloud for waveform A, for the high-speed read aloud for waveform B, the phoneme length of a phoneme d after a pause is reduced (to 15 ms in this example) in proportion to the speech speed.

In contrast, FIG. 26a represents a waveform obtained when the processing (shown in the flowchart in FIG. 6) in the first embodiment is performed at a normal speed and B represents a waveform obtained when the phoneme length of the speech head immediately after the pause is increased so as to correspond to high-speed read-aloud.

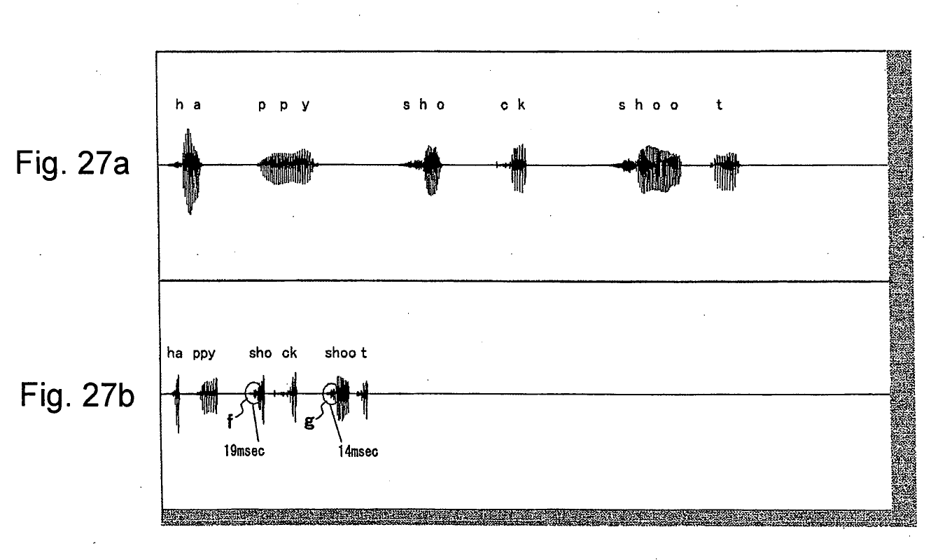

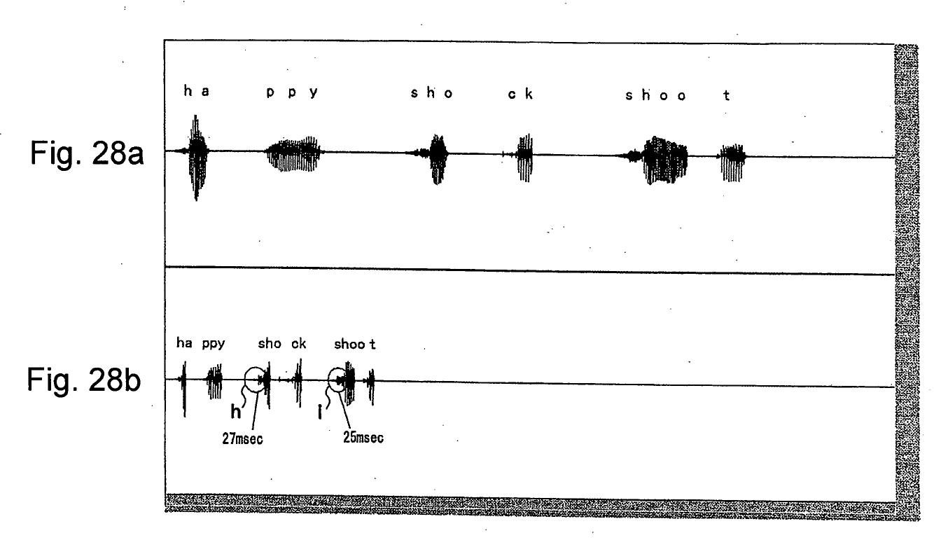

When e in waveform in FIG. 26b is compared with d in waveform in FIG. 25b, the phoneme length of the phoneme at the speech head immediately after the pause is increased (secured) to a phoneme length that is greater than the phoneme length that is proportional to the speech speed, i.e., is increased to 35 ms. That is, in this example (e in waveform in FIG. 26b), the phoneme length is increased to about 2.3 times. Thus, no sound drop occurs and ease of hearing is enhanced. Third Example Waveforms resulting from processing according to a third example will now be described with reference to FIGS. 27 and 28. FIG. 27 shows speech-synthesis waveforms of a comparative example, and FIG. 28 shows speech-synthesis waveforms according to a third example. While the waveforms illustrated in the first and second examples are obtained from Japanese Language, the waveforms illustrated in the third example are obtained by reading aloud English words “ha ppy, sho ck, shoo t”.

FIG. 27a represents a waveform obtained at a normal read-aloud speed and B represents a waveform obtained at a high read-aloud speed. Compared to the normal-speed read aloud for waveform A, for the high-speed read aloud for waveform A, the phoneme lengths immediately after pauses f and g are reduced in proportional to the speech speed, i.e., is reduced to 19 ms at the portion f and 24 ms at the portion g in this example.

In contrast, FIG. 28a represents a waveform obtained when the processing (shown in the flowchart in FIG. 6) in the first embodiment is performed at the normal speed and B represents a waveform obtained when the phoneme lengths of speech heads immediately after the pauses are increased so as to correspond to high-speed read-aloud.

When h and i in waveform in FIG. 28b are compared with f and d in waveform in FIG. 27b, the phoneme lengths of the phonemes at the speech heads immediately after the pauses are increased (secured) to phoneme lengths that are greater than the phoneme lengths proportional to the speech speed, i.e., are increased to 27 ms for h and 25 ms for i in waveform in FIG. 28b. That is, in this example the phoneme length is increased to about double the phoneme length that is proportional to the speech speed. Thus, no sound drop occurs and ease of hearing is enhanced.

### Fourth Example

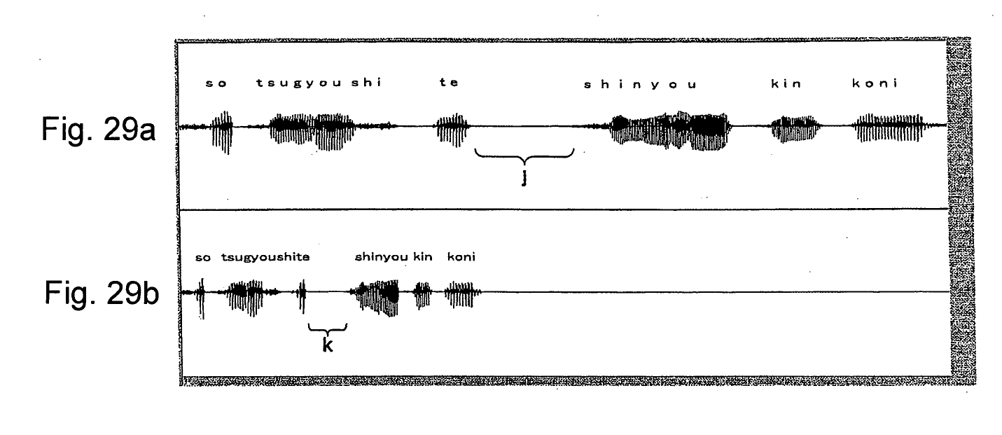

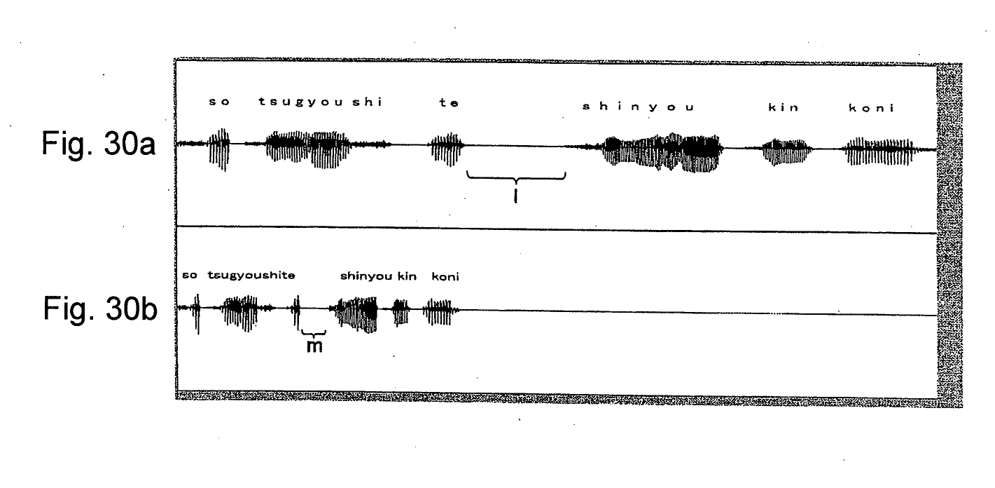

Waveforms resulting from processing according to a fourth example will now be described with reference to FIGS. 29 and 30. FIG. 29 shows speech-synthesis waveforms of a comparative example, and FIG. 30 shows speech-synthesis waveforms according to a fourth example. FIG. 29a represents a waveform obtained at a normal read-aloud speed, and B represents a waveform obtained at a high read-aloud speed. A pause section j in the case of the normal read-aloud speed for waveform A changes to a pause section k in the case of the high-speed read aloud for waveform B, so that the length of the pause section is reduced in accordance with the speech speed.

In contrast, FIG. 30a represents a waveform obtained when the processing (shown in the flowchart in FIG. 16) in the ninth embodiment is performed at the normal speed, and 1 represents a pause section in this case. B represents a waveform obtained when the pause length is reduced more than the pause length reduced in accordance with the speech speed so as to correspond to the high-speed read aloud, and m represents a pause section in this case.

When the pause section m in waveform in FIG. 30b is compared with the pause section k in waveform in FIG. 29b, the pause section is reduced to the pause section m that is proportional to the speech speed. This reduces the amount of read-aloud time without causing sound dropout, i.e., without compromising ease of hearing.

### Fifth Example

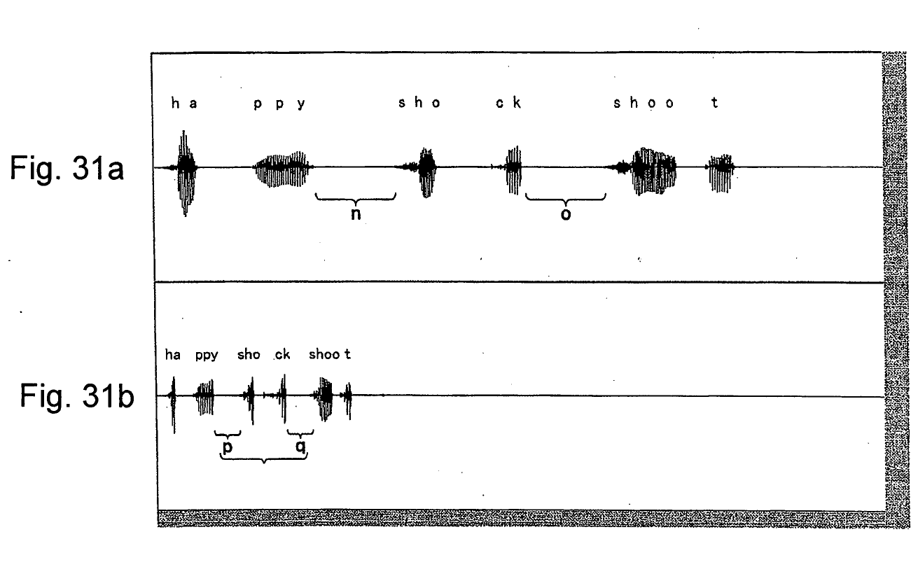

Waveforms resulting from processing according to a fifth example will now be described with reference to FIG. 31. While the first, second, and fourth examples are directed to Japanese language, the fifth example is directed to a case in which English sentence “ha ppy sho ck shoo t” is read aloud, as in the third example.

FIG. 31a represents a waveform obtained when the processing in the ninth embodiment, (the flowchart in FIG. 19) is performed during normal-speed read aloud, and n and o represent pause sections in this case, B represents a waveform obtained when the pause lengths are reduced more than the pause lengths reduced so as to correspond to the speech speed, and p and q represent pause sections in this case.

When the pause sections p and q in waveform in FIG. 31b are compared with the pause sections n and o in waveform A, the pause sections are reduced more than the pause sections n and o that are proportional to the speech speed. This reduces the amount of read-aloud time without causing sound dropout, i.e., without compromising ease of hearing.

Technical ideas according to the above-described embodiments of the present invention will be described below.

While preferred embodiments of the present invention and so on according to the present invention have been described above, the present invention is not limited to thereto. Thus, naturally, it is apparent to those skilled in the art that various modifications and changes can be made based on the appended claims or the subject matter of the present invention disclosed herein. Needless to say, such modifications and changes are also encompassed by the scope of the present invention.

What is claimed is:

1. An apparatus for converting text data into sound signal, comprising:
a phoneme determiner for determining phoneme data corresponding to a plurality of phonemes and pause data corresponding to a plurality of pauses to be inserted among a series of phonemes in the text data to be converted into sound signal;
a phoneme length adjuster for modifying the phoneme data and the pause data by determining lengths of the phonemes, respectively in accordance with a speed of the sound signal and selectively adjusting the length of at least one of the phonemes which is placed immediately after one of the pauses so that the at least one of the phonemes is relatively extended timewise as compared to other phonemes; and
an output unit for outputting sound signal on the basis of the adjusted phoneme data and pause data by the phoneme length adjuster.

2. The apparatus according to claim 1, wherein the phoneme length adjuster modifies the pause data by reducing a pause length in the text data to a pause length which is shorter than the pause length corresponding to the speed of the sound signal.

3. The apparatus according to claim 1 further comprising:
a speed determiner for determining a speed of the sound signal;
wherein when the speed determiner determines that the speed of the sound signal is higher than predetermined speed, the phoneme length adjuster modifies the phoneme data by increasing the phoneme length of the phoneme immediately after one of the pause.

4. The apparatus according to claim 1, wherein when the phoneme determiner determines that the phoneme is a fricative, the phoneme length adjuster modifies the phoneme data by increasing the length of the fricative phoneme.

5. The apparatus according to claim 1, further comprising:
a breath-group calculator for calculating a length of a breath group,
wherein the phoneme length adjuster modifies the phoneme data and pause data by increasing or reducing proportionally phoneme lengths and pause lengths in the breath group in accordance with the length of the breath group.

6. The apparatus according to claim 1, further comprising:
a sentence calculator for calculating a length of a read-aloud sentence of the text data,
wherein the phoneme length adjuster proportionally modifies the phoneme data and pause data by increasing or reducing proportionally phoneme lengths and pause lengths in the sentence in accordance with the length of the read-aloud sentence of the text data.

7. The apparatus according to claim 1, wherein when the speed of the sound signal is higher than predetermined speed, the phoneme length adjuster modifies the pause data by reducing a pause length in the text data to a pause length which is less than the pause length corresponding to the speed of the sound signal.

8. The apparatus according to claim 1, wherein when the speed of the sound signal is higher than predetermined speed, the phoneme length adjuster modifies the pause data by removing at last one pause in the text data.

9. The apparatus according to claim 1, wherein the phoneme length adjuster modifies the phoneme data and the pause data by reducing other phoneme lengths and other pause lengths so as to correspond to an increase in the phoneme length.

10. A method for converting text data into sound signal, comprising the steps of:
determining phoneme data corresponding to a plurality of phonemes and pause data corresponding to a plurality of pauses to be inserted among a series of phonemes in the text data to be converted into sound signal;
modifying the phoneme data and the pause data by determining lengths of the phonemes, respectively in accordance with a speed of the sound signal and selectively adjusting the length of at least one of the phonemes which is placed immediately after one of the pauses so that the at least one of the phonemes is relatively extended timewise as compared to other phonemes; and
outputting sound signal on the basis of the adjusted phoneme data and pause data.

11. The method according to claim 10, further comprising the steps of:
determining a speed of the sound signal; and
modifying the phoneme data by increasing the phoneme length of the phoneme immediately after one of the pause when the speed of the sound signal is higher than predetermined speed.

12. The method according to claim 10, further comprising a step of:
determining whether or not the phoneme is a fricative, and
modifying the phoneme data by increasing the length of the fricative phoneme.

13. The method according to claim 10, further comprising the steps of:
calculating a length of a breath group; and
modifying the phoneme data by increasing or reducing proportionally phoneme lengths in the breath group in accordance with the length of the breath group.

14. The method according to claim 10, further comprising the steps of:
calculating a length of a read-aloud sentence of the text data; and
modifying the phoneme data by increasing or reducing proportionally phoneme lengths in the sentence in accordance with the length of the read-aloud sentence of the text data.

15. The method according to claim 10, further comprising the steps of:
modifying the pause data by reducing a pause length in the text data to a pause length which is less than the pause length corresponding to the speed of the sound signal, when the speed of the sound signal is higher than predetermined speed.

16. The method according to claim 10, further comprising the steps of:
modifying the pause data by removing at last one pause in the text data, when the speed of the sound signal is higher than predetermined speed.

17. The method according to claim 10, further comprising the steps of:
modifying the phoneme data and the pause data by reducing other phoneme lengths and other pause lengths so as to correspond to an increase in the phoneme length.

18. An apparatus for converting text data into sound signal, comprising:
a processor for performing a process of converting the text data into sound signal comprising the steps of:
determining data corresponding to a plurality of phoneme types in the text data to be converted into sound signal;
determining phoneme data corresponding to a plurality of phonemes and pause data corresponding to a plurality of pauses to be inserted among a series of phonemes in the text data to be converted into sound signal;
modifying the phoneme data and the pause data by determining lengths of the phonemes, respectively in accordance with a speed of the sound signal and selectively adjusting the length of at least one of the phonemes which is placed immediately after one of the pauses so that the at least one of the phonemes is relatively extended timewise as compared to other phonemes; and
an output unit for outputting sound signal on the basis of the adjusted phoneme data and pause data.
